(19) United States
(12) Patent Application Publication
(10) Pub. No.: US 2026/0162420 A1
(43) Pub. Date: Jun. 11, 2026

(54) IMAGE PROCESSING APPARATUS AND OPERATING METHOD THEREOF

(71) Applicant: SAMSUNG ELECTRONICS CO., LTD., Suwon-si (KR)

(72) Inventors: Sanghun KIM, Suwon-si (KR); Jinhwan BAIK, Suwon-si (KR); Woonsung PARK, Suwon-si (KR)

(73) Assignee: SAMSUNG ELECTRONICS CO., LTD., Suwon-si (KR)

(21) Appl. No.: 19/430,905

(22) Filed: Dec. 23, 2025

Related U.S. Application Data
(63) Continuation of application No. PCT/KR2025/020254, filed on Dec. 1, 2025.

(30) Foreign Application Priority Data
Dec. 5, 2024 (KR) 10-2024-0179690

(51) Int. Cl. G06V 10/82; G06N 3/045; G06N 3/08

(52) U.S. Cl. CPC G06V 10/82; G06N 3/045; G06N 3/08

(57) ABSTRACT

An image processing apparatus includes memory storing one or more instructions and at least one processor. When executed, the instructions cause the apparatus to obtain a power consumption reduction request and, in response, obtain, from pre-stored profiling data of a first neural network model, a threshold value for converting one or more parameters of the first neural network model to zero. The profiling data includes information indicating the threshold value, performance information for a second neural network model generated by converting the one or more parameters of the first neural network model to zero based on the threshold value, and power consumption reduction estimation information for the second neural network model. The instructions further cause the apparatus to obtain an output image from the second neural network model by processing an input image through the second neural network model in which the one or more parameters are converted to zero.

### CROSS-REFERENCE TO RELATED APPLICATIONS

This application is a by-pass continuation application of International Application No. PCT/KR2025/020254, filed on December 1, 2025, which is based on and claims priority to Korean Patent Application No. 10-2024-0179690, filed on December 5, 2024, in the Korean Intellectual Property Office, the disclosures of which are incorporated by reference herein in their entireties.

### BACKGROUND

### 1. Field

The disclosure relates to the field of image processing, and more particularly, to an apparatus and method for processing an image so as to improve the quality of the image.

### 2. Description of Related Art

In the fields of image processing and computer vision, artificial intelligence (AI) has achieved performance improvements that were previously impossible. However, AI-based image processing algorithms have the limitation of requiring a high amount of computation. Recently, along with the light weighting of these image processing algorithms, the performance of hardware for computing image processing algorithms has been improved and optimized, realizing an on-device method that performs AI-based image processing within the device. On-device means running AI-based algorithms directly on the device itself, such as smartphones, tablets, and Internet of Things (IoT) devices, rather than on a cloud server.

In particular, as the performance of processing units specialized in image processing neural networks improves, on-device operations utilizing processing units are becoming more widely utilized.

### SUMMARY

According to an aspect of the disclosure, an image processing apparatus includes memory storing one or more instructions; and at least one processor, wherein the one or more instructions, when executed by the at least one processor, individually or collectively, cause the image processing apparatus to obtain a power consumption reduction request; in response to the power consumption reduction request, obtain, from pre-stored profiling data of a first neural network model, a threshold value for converting one or more parameters of the first neural network model to zero, wherein the profiling data includes (i) information indicating the threshold value, (ii) performance information for a second neural network model that is generated by converting the one or more parameters of the first neural network model to zero based on the threshold value, and (iii) power consumption reduction estimation information for the second neural network model; and obtain an output image from the second neural network model by processing an input image through the second neural network model.

The profiling data may further include at least one of (i) quantitative evaluation information for performance of a plurality of second neural network models in which one or more weights are converted to zero based on different threshold values, or (ii) qualitative evaluation information for the performance of the plurality of second neural network models.

As the threshold value increases, the performance of the plurality of second neural network models may decrease and a power consumption reduction estimation amount of the plurality of second neural network models may increase.

The least one processor may include at least one first processor and a second processor. The one or more instructions, when executed by the at least one first processor, individually or collectively, may cause the image processing apparatus to obtain a target reduction amount with the power consumption reduction request for the second processor; and identify, from the profiling data, a threshold value for at least one second neural network model having a power consumption reduction estimation amount that corresponds to the target reduction amount.

The one or more instructions, when executed by the at least one processor, individually or collectively, may cause the image processing apparatus to deactivate the first neural network model in response to the at least one second neural network model failing to satisfy a minimum performance that is based on the performance of the first neural network model.

The one or more instructions, when executed by the at least one processor, individually or collectively, may cause the image processing apparatus to obtain corresponding threshold values for parameters of a plurality of first neural network models of different types, based on power consumption reduction estimation information in the profiling data for the plurality of first neural network models; and obtain the output image by processing the input image through a plurality of second neural network models corresponding to the plurality of first neural network models.

The one or more instructions, when executed by the at least one processor, individually or collectively, may cause the image processing apparatus to deactivate at least one first neural network model from among the plurality of first neural network models, based on a deactivation priority included in the profiling data.

The at least one processor may include at least one first processor and a second processor. The second processor may include a plurality of operators. The one or more instructions, when executed by the at least one first processor, individually or collectively, may cause the image processing apparatus to use the second processor to obtain the output image by performing, via the second processor, an operation using an operator of the plurality of operators based on a parameter input to the operator not being within a threshold value range; and not performing the operation based on a parameter input to the operator being within the threshold value range.

The one or more instructions, when executed by the at least one first processor, individually or collectively, may cause the image processing apparatus to generate the second neural network model by converting a parameter of the first neural network model to zero based on the parameter having a value within a threshold value range; transmit, to the second processor, parameter information of the second neural network model and the input image; and cause the image processing apparatus to use the second processor to obtain the output image by performing, via the second processor, an operation using an operator of the plurality of operators based on a parameter input to the operator being non-zero; and not performing the operation based on the parameter input to the operator being zero.

The one or more instructions, when executed by the at least one first processor, may cause the image processing apparatus to transmit, to the second processor, parameter information of the first neural network model, information indicating the threshold value, and the input image; and cause the image processing apparatus to use the second processor to obtain the output image by performing, via the second processor, an operation using an operator of the plurality of operators based on a parameter input to the operator not being within a threshold value range; and not performing the operation based on the parameter input to the operator being within the threshold value range.

The parameter input to the operator may be determined to be within the threshold value range by based on the parameter being negative and the threshold value being 2p, where p is an integer, performing an OR operation between a first modified threshold value and a first modified parameter, and identifying the parameter as being within the threshold value range when all bits of a result of the OR operation are one; and based on the parameter being positive and the threshold value being 2p, performing an AND operation between a second modified threshold value and a second modified parameter, and identifying the parameter as being within the threshold value range when all bits of a result of the AND operation are zero.

According to an aspect of the disclosure, an operating method of an image processing apparatus, the operating method includes obtaining a power consumption reduction request; in response to the power consumption reduction request, obtaining, from pre-stored profiling data of a first neural network model, a threshold value for converting one or more parameters of the first neural network model to zero, wherein the profiling data includes (i) information indicating the threshold value, (ii) performance information for a second neural network model that is generated by converting the one or more parameters of the first neural network model to zero based on the threshold value, and (iii) power consumption reduction estimation information for the second neural network model; and obtaining an output image from the second neural network model by processing an input image through the second neural network model.

The profiling data may further include at least one of (i) quantitative evaluation information for performance of a plurality of second neural network models in which one or more weights are converted to zero based on different threshold values, or (ii) qualitative evaluation information for the performance of the plurality of second neural network models.

As the threshold value increases, the performance of the plurality of second neural network models may decrease, and a power consumption reduction estimation amount of the plurality of second neural network models may increase.

The method may further include obtaining a target reduction amount with the power consumption reduction request for a second processor; and identifying, from the profiling data, a threshold value for at least one second neural network model having a power consumption reduction estimation amount that corresponds to the target reduction amount.

The method may further include deactivating the first neural network model in response to the at least one second neural network model failing to satisfy a minimum performance that is based on the performance of the first neural network model.

The method may further include obtaining corresponding threshold values for parameters of a plurality of first neural network models of different types, based on power consumption reduction estimation information in the profiling data for the plurality of first neural network models; and obtaining the output image by processing the input image through a plurality of second neural network models corresponding to the plurality of first neural network models.

The method may further include deactivating at least one first neural network model from among the plurality of first neural network models, based on a deactivation priority included in the profiling data.

The obtaining of the output image may include performing, via a second processor, an operation using an operator of a plurality of operators based on a parameter input to the operator not being within a threshold value range; and not performing the operation based on a parameter input to the operator being within the threshold value range.

According to an aspect of the disclosure, a non-transitory computer-readable recording medium having at least one instruction recorded thereon, that, when executed by at least one processor, individually or collectively, causes the at least one processor to obtain a power consumption reduction request; in response to the power consumption reduction request, obtain, from pre-stored profiling data of a first neural network model, a threshold value for converting one or more parameters of the first neural network model to zero, wherein the profiling data includes (i) information indicating the threshold value, (ii) performance information for a second neural network model that is generated by converting the one or more parameters of the first neural network model to zero based on the threshold value, and (iii) power consumption reduction estimation information for the second neural network model; and obtain an output image from the second neural network model by processing an input image through the second neural network model.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram of an example of an image processing process by an image processing apparatus according to an embodiment of the disclosure.

FIG. 2 is a block diagram illustrating a configuration of an image processing apparatus according to an embodiment of the disclosure.

FIG. 3 is a flowchart for describing an operating method of an image processing apparatus, according to an embodiment of the disclosure.

FIG. 4 is a block diagram for describing an image processing operation by an image processing apparatus according to an embodiment of the disclosure.

FIG. 5 is an example of profiling data of a first neural network model according to an embodiment of the disclosure.

FIG. 6A shows examples of output images for qualitative evaluation of neural network models in the profiling data in FIG. 5.

FIG. 6B shows examples of output images for quantitative evaluation of neural network models through peak signal-to-noise ratio (PSNR) in the profiling data in FIG. 5.

FIG. 7 is an example of profiling data of the first neural network model according to an embodiment of the disclosure.

FIG. 8 is a flowchart of a method by which an image processing apparatus according to an embodiment of the disclosure obtains a threshold value for the first neural network model.

FIG. 9 is a flowchart of a method by which an image processing apparatus according to an embodiment of the disclosure obtains a threshold value for each of a plurality of first neural network models.

FIG. 10 shows an example of an operation of determining, by an image processing apparatus according to an embodiment of the disclosure, power reduction or deactivation of a plurality of first neural network models.

FIG. 11 is a block diagram for describing an operator and a first parameter identification circuit of a second processor according to an embodiment of the disclosure.

FIG. 12 is a diagram for describing a neural network model that is computed in a second processor according to an embodiment of the disclosure.

FIG. 13 is a block diagram for describing an image processing operation by an image processing apparatus according to an embodiment of the disclosure.

FIG. 14 is a block diagram for describing an operator and a second parameter identification circuit of a second processor according to an embodiment of the disclosure.

FIG. 15 is a flowchart of a method by which an image processing apparatus according to an embodiment of the disclosure determines whether a parameter of a neural network model is within a threshold value range.

FIG. 16 is a table showing the relationship between decimal and binary numbers in two’s complement system, which includes sign bit.

FIG. 17 is a table for determining whether a parameter input to a second processor is within a threshold value range when the parameter is a negative number, according to an embodiment of the disclosure.

FIG. 18 is a table for determining whether a parameter input to a second processor is within a threshold value range when the parameter is a positive number, according to an embodiment of the disclosure.

FIG. 19 is a detailed block diagram of an image processing apparatus according to an embodiment of the disclosure.

### DETAILED DESCRIPTION

Throughout the disclosure, the expression “at least one of a, b, or c” indicates “a”, “b”, “c”, “a and b”, “a and c”, “b and c”, “all of a, b, and c”, or any modifications thereof.

Hereinafter, an embodiment of the disclosure will be described in detail with reference to the accompanying drawings so that the embodiments of the disclosure may be easily implemented by one of ordinary skill in the art. However, the disclosure may be embodied in many different forms and is not limited to an embodiment of the disclosure set forth herein.

Terms used in the disclosure are described as general terms currently used in consideration of functions described in the disclosure, but the terms may have different meanings according to an intention of one of ordinary skill in the art, precedent cases, or the appearance of new technologies. Thus, the terms used herein should not be interpreted only by its name, but have to be defined based on the meaning of the terms together with the description throughout the disclosure.

Also, the terms used herein are for the purpose of describing a certain embodiment of the disclosure only and are not intended to be limiting of the disclosure.

Throughout the specification, when a part is “connected” to another part, the part may not only be “directly connected” to the other part, but may also be “electrically connected” to the other part with another element in between.

As used herein, and particularly in the claims, the article “the” and similar referents may be used to indicate both singular and plural forms. Operations for describing a method according to the disclosure may be performed in a suitable order unless the context clearly dictates otherwise. The disclosure is not limited to the order of the operations described.

The expression “in an embodiment” and the like appearing in various parts of the specification are not intended to refer to the same embodiment.

Some embodiments of the disclosure may be represented by functional block configurations and various processing operations. Some or all of the functional blocks may be implemented by various numbers of hardware and/or software configurations for performing certain functions. For example, the functional blocks of the disclosure may be implemented by one or more microprocessors or by circuit configurations for a certain function. Also, for example, the functional blocks of the disclosure may be implemented in various programming or scripting languages. The functional blocks may be implemented in an algorithm executed by one or more processors. In addition, the disclosure may employ general techniques for electronic environment setting, signal processing, and/or data processing. The words “mechanism”, “element”, “means”, and “configuration” are used broadly and are not limited to mechanical or physical embodiments.

Also, lines or members connecting elements illustrated in the drawings are merely illustrative of functional connections and/or physical or circuit connections. In an actual device, connections between components may be represented by various functional connections, physical connections, or circuit connections that are replaceable or added.

In addition, terms such as “unit”, “module”, and the like used in the disclosure indicate a unit which processes at least one function or motion, and may be implemented by hardware or software, or by a combination of hardware and software.

In the disclosure, the term “processor” may include various processing circuitry and/or a plurality of processors. For example, the term “processor” as used herein including the claims may include various processing circuitry including at least one processor. In at least one processor, one or more processors may be configured to individually and/or collectively perform various functions described herein, in a distributed manner. As used herein, the terms “processor”, “at least one processor”, and “one or more processors” may be configured to perform a variety of functions. However, such terms cover, without limitations, situations where one processor performs some of the functions and other processor(s) perform the other functions, and situations where a single processor performs all of the functions. In addition, the at least one processor may include a combination of processors configured to perform various functions of the disclosed functions in a distributed manner. The at least one processor may execute program instructions to achieve or perform various functions.

In the disclosure, the term “user” indicates a person using an electronic apparatus, and may include a consumer, an evaluator, a viewer, an administrator, or an installer. In addition, the term “manufacturer” or “provider” as used herein may indicate a manufacturer manufacturing an electronic apparatus and/or an element included in the electronic apparatus.

In the disclosure, the term “image” may include including still images, graphics, pictures, frames, or moving images, or videos, including a plurality of consecutive still images.

In the disclosure, the term “neural network” is a representative example of an artificial neural network model simulating brain neurons, and is not limited to artificial neural network models using a particular algorithm. A neural network may also be referred to as a deep neural network.

Hereinafter, the disclosure will be described in detail with reference to the accompanying drawings.

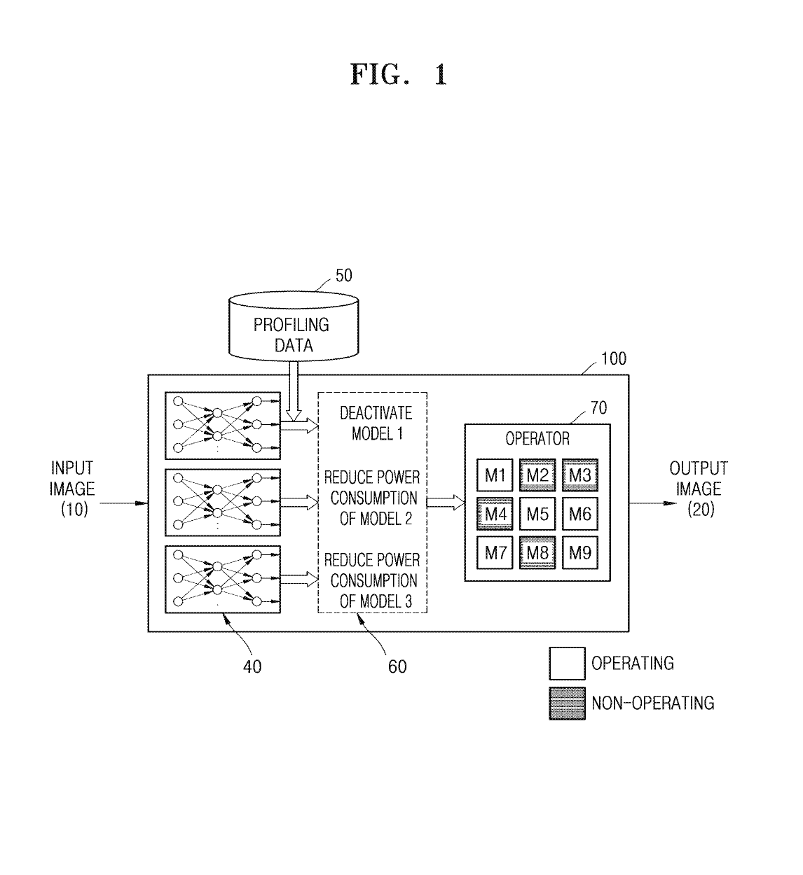

FIG. 1 is a diagram of an example of an image processing process by an image processing apparatus according to an embodiment of the disclosure.

Referring to FIG. 1, an image processing apparatus 100 of the disclosure may be an electronic apparatus capable of processing and outputting images. The image processing apparatus 100 may be implemented in various forms including a display. For example, the image processing apparatus 100 may be implemented as various electronic apparatuses such as mobile phones, tablet personal computers (PCs), digital cameras, camcorders, laptop computers, desktops, electronic book terminals, terminals for digital broadcasting, personal digital assistants (PDAs), portable multimedia players (PMPs), navigations, MPEG-3(MP3) players, or wearable devices.

The image processing apparatus 100 according to an embodiment of the disclosure may perform image processing on an input image 10 and generate an output image 20. For example, the image processing apparatus 100 may generate the output image 20 by applying, to the input image 10, at least one algorithm from among a noise cancellation algorithm, an up-scaling algorithm, a sharpness enhancement algorithm, a contrast enhancement (CE) algorithm, a color correction algorithm, and a frame rate conversion (FRC) algorithm. However, the image processing processes performed by the image processing apparatus 100 are not limited to the examples described above.

In an embodiment of the disclosure, in the image processing apparatus 100, an image processing algorithm may be implemented as a neural network model. The image processing apparatus 100 may perform a computation on a neural network model in an on-device manner in the device, by using a processing unit specialized for computation for a neural network model. However, the amount of resources (e.g., memory, operator, and bandwidth) for processing computations for a neural network model in the specialized processing unit may be limited. When computation for a plurality of neural network models is processed using the limited resources of the processing unit, the computation amount of the processing unit may increase, and the power consumption and heat generation of the processing unit may increase rapidly.

The image processing apparatus 100 has a limitation that a particular image processing algorithm must be deactivated when the power consumption and heat generation of the processing unit exceed the limit. For example, when the heat generation amount of the processing unit exceeds the limit in a situation where three neural network models are operating in the processing unit, the image processing apparatus 100 may stop the operation of at least one neural network model from among the three neural network models so as to reduce the heat generation amount. Because the image processing apparatus 100 adjusts the heat generation amount of the processing unit through deactivation of a neural network model, an image of the target quality may not be obtained or the image processing operation may be delayed.

In the image processing apparatus 100 according to an embodiment of the disclosure, it may be provided a method for reducing power consumption or heat generation of a processing unit while performing an image processing operation to obtain an image of the target quality, so as to execute neural network models of various purposes by using the processing unit.

The image processing apparatus 100 according to an embodiment of the disclosure, a neural network model 60 with reduced computation amount may be generated by reducing power consumption of a neural network model 40 required for image processing (see “Model 2” and “Model 3” in FIG. 1). The image processing apparatus 100 may perform image processing on the input image 10 by using the neural network model 60 with reduced computation amount, so as to generate the output image 20.

In the disclosure, the reduction in power consumption of the neural network model may indicate that one or more of the parameters of the neural network model are converted to zero, and the computation amount of the processing unit is reduced by a ratio of the parameters converted to zero. Accordingly, the computation amount of the processing unit may be reduced by the ratio of the parameters converted to zero, and the power consumption and heat generation of the entire processing unit may be reduced by the amount of computation reduction.

The image processing apparatus 100 according to an embodiment of the disclosure may determine whether to reduce power consumption of each neural network model, or a ratio of power consumption reduction for each neural network model, by using profiling data 50 prepared in advance for each neural network model. For example, the image processing apparatus 100 may determine a threshold value for converting one or more of the parameters of the neural network to zero, by using the profiling data 50.

In the disclosure, the profiling data 50 may include information for identifying a trade-off relationship between the performance and the power consumption of a neural network model. The profiling data 50 may include information about a power consumption reduction estimation amount that varies depending on the threshold value for converting some of the parameters of the neural network model to zero.

In the disclosure, the threshold value of the parameters of a neural network model may indicate a reference value for the parameters of the neural network model to be converted to zero. The image processing apparatus 100 may convert the parameter within a particular range to zero by using the threshold value of the parameter. For example, when the threshold value is 2, the image processing apparatus 100 may convert, to zero, a parameter having a value between -2 to 2 from among the parameters of the neural network model.

As the threshold value of the parameter of the neural network model increases, the number of parameters converted to zero from among the total parameters of the neural network model increases. In addition, as the number of parameters converted to zero from among the total parameters of the neural network model, power consumption required to compute the neural network model may reduce, but the performance of the neural network model may be deteriorated. Accordingly, the image processing apparatus 100 may identify, by using the profiling data 50, an appropriate threshold value that can reduce power consumption while minimizing performance deterioration of the neural network. The image processing apparatus 100 may obtain a low-power neural network model 60 by converting a parameter within the identified threshold value range to zero.

The image processing apparatus 100 according to an embodiment of the disclosure may transfer the neural network model 60 to an operator 70 of the processing unit. The image processing apparatus 100 may perform computation on the low-power neural network model 60 through the operator 70. The operator 70 is a resource of the processing unit and may include a plurality of operators M1 to M9 for performing multiplication, addition, convolutional operation, etc. on the neural network model. Here, when the parameter value input to a multiplier is zero, the result may be 0 no matter what value is multiplied. When the input parameter value is zero, the operator 70 may not perform computation on the neural network so as to reduce unwanted power consumption and heat generation. For example, when the low-power neural network model 60 is used (or operated), five (e.g., M1, M5, M6, M7, and M9) out of a total of nine operators may be used, and four (e.g., M2, M3, M4, and M8) may not be used (or non-operated). By using the low-power neural network model 60, the image processing apparatus 100 may reduce the power consumption and heat generation of the processing unit while maintaining the performance of the neural network model.

The image processing apparatus 100 may deactivate the neural network model when it is determined by using the profiling data 50 that deactivating the neural network model is more effective in terms of power consumption to reach the requested target reduction amount. For example, the image processing apparatus 100 may stop execution of the neural network model itself rather than reducing power consumption of the neural network model.

In the disclosure, deactivating the neural network model indicates stopping an image processing algorithm corresponding to the corresponding neural network model, and power consumption of the entire processing unit may be reduced by the amount of computation of the operator 70 that is required to execute the neural network model. Deactivating the neural network model may indicate converting all of the parameters of the neural network model to zero.

In the disclosure, the neural network model 40 may be referred to as a first neural network model. The first neural network model may indicate a model in an initial state in which a neural network model corresponding to an algorithm processing algorithm is not low-powered. The first neural network model may have an initial parameter. The first neural network model may be an initial model or a reference model of a second neural network model.

In the disclosure, a low-power neural network 60 may be referred to as a second neural network model. The second neural network model may indicate a neural network model in which one or more of the parameters of the first neural network model are converted to zero. The second neural network model may have parameters in which one or more of the initial parameters are converted to zero.

The neural network models may be in a deployed state after training is completed. The image processing apparatus 100 may use the low-power neural network model by adjusting the parameters rather than performing re-training or fine-training to reduce power consumption of the neural network models.

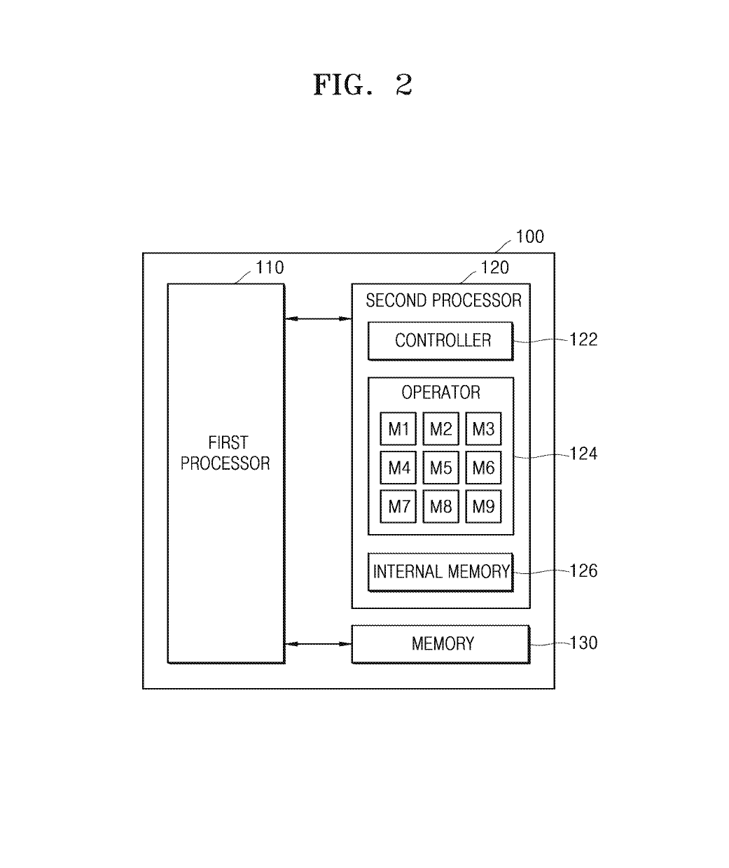

FIG. 2 is a block diagram illustrating a configuration of the image processing apparatus according to an embodiment of the disclosure.

Referring to FIG. 2, the image processing apparatus 100 according to an embodiment of the disclosure may include a first processor 110, a second processor 120, and memory 130.

The first processor 110 may control the image processing apparatus 100 as a whole. The first processor 110 according to an embodiment of the disclosure may execute one or more programs stored in the memory 130. The first processor 110 according to an embodiment of the disclosure may include one or more processors.

The one or more processors included in the first processor 110 may be a general-purpose processor, such as a central processing unit (CPU), an application processor (AP), or a digital signal processor (DP), a graphics-only processor, such as a graphics processing unit (GPU) or a vision processing unit (VPU), or an artificial intelligence-only processor,, such as a neural processing unit (NPU). The first processor 110 may be circuitry implemented in the form of a system on chip (SoC) or integrated circuit (IC) in which at least one of a CPU, a GPU, a VPU, or an NPU is integrated.

The memory 130 may store various data, programs, or applications for driving and controlling the image processing apparatus 100. The programs stored in the memory 130 may include one or more instructions. The programs (one or more instructions) or applications stored in the memory 130 may be executed by the first processor 110.

The memory 130 is a configuration for storing various programs or data and may include a storage medium, such as read-only memory (ROM), random-access memory (RAM), a hard disk, compact-disc read-only memory (CD-ROM), and digital versatile disc (DVD), or a combination of storage media. The memory 130 may not exist separately and may be configured to be included in the first processor 110. The memory 130 may include volatile memory, non-volatile memory, or a combination of volatile memory and non-volatile memory. The memory 130 may store a program or at least one instruction for performing operations according to embodiments described below. The memory 130 may provide the stored data to the first processor 110 in response to a request by the first processor 110.

The second processor 120 may include an artificial intelligence-only processor specialized for neural network computation. The second processor 120 may include one or more processors for executing a neural network. The one or more processors included in the second processor 120 may include a GPU, an NPU, or a tensor processing unit (TPU). The second processor 120 may be manufactured in the form of a hardware chip dedicated for artificial intelligence, or may be manufactured as part of the existing general-purpose processor (e.g., a CPU or an AP) or part of a graphics-only processor (e.g., a GPU). The second processor 120 may also be implemented in the form of a single chip integrated with the first processor 110.

The second processor 120 according to an embodiment of the disclosure may include a controller 122, an operator 124, and internal memory 126. The second processor 120 may include at least one of hardware resources, software resources, or logic resources that are required or used for executing various neural network models.

The controller 122 may include a scheduler configured to control a computation of the operator 124 for inferential computation of the second processor 120 and an order of reading and writing of the internal memory 126. The scheduler within the controller 122 may include a circuit for controlling the operator 124 and the internal memory 126. The controller 122 may control an inferential operation of the neural network model of the second processor 120.

The operator 124 may include a plurality of operators for performing multiplication, addition, convolutional operation, etc. on the neural network model. The plurality of operators may be disposed in the second processor 120 to compute a feature map and weight data of the neural network model. Each of the operators may include a multiply and accumulate (MAC) operator, an arithmetic logic unit (ALU) operator, or the like. The MAC operator may include a multiplier, an adder, and an accumulator. For example, the operator 124 may include a plurality of MAC operators. Each of the plurality of MAC operators may be disposed in parallel within the second processor 120. However, an embodiment of the disclosure is not limited thereto.

In an embodiment of the disclosure, the MAC operator may further include a parameter identification circuit. The MAC operator may identify through the parameter identification circuit, whether a parameter input to the MAC operator corresponds to a certain value. When the parameter input to the MAC operator corresponds to the certain value, the parameter identification circuit may control to not perform an operation on the corresponding MAC operator. Here, the certain value may be zero or a threshold value, but is not limited thereto. For example, the first parameter identification circuit may be a circuit for identifying whether a parameter input to the MAC operator corresponds to zero. For example, the second parameter identification circuit may be a circuit for identifying whether the parameter input to the MAC operator is within a threshold value range. In an embodiment of the disclosure, a parameter identification circuit may be provided for each MAC operator, but the disclosure is not limited thereto.

The internal memory 126 may store information about a plurality of neural network models. The neural network model may include image processing neural networks for various purposes that are input to the image processing apparatus 100. In addition, for computation of a neural network model, the internal memory 126 within the second processor 120 may temporarily store parameters, such as an input feature map and an output feature map, an activation map, or a weight kennel. To this end, the internal memory 126 within the second processor 120 may include an input feature map storage unit, an output feature map storage unit, a weight storage unit, and etc.

In an embodiment of the disclosure, the internal memory 126 may store a neural network model, parameters of the neural network model, and video data corresponding to an input image. In an embodiment of the disclosure, the internal memory 126 may store parameters of a low-power neural network model in which one or more of the parameters of the neural network model are converted to zero. The internal memory 126 may store initial parameters of the neural network model and threshold values to be applied to the respective parameters.

In an embodiment of the disclosure, the first processor 110 may execute the one or more instructions stored in the memory 130 to obtain a power consumption reduction request. When the request is obtained, the first processor 110 may obtain, based on the profiling data of the first neural network model, a threshold value of a parameter for converting one or more of the parameters within the first neural network model to zero. The first processor 110 may obtain, based on the threshold value of the parameter, an output image that is obtained by image processing the input image through the second neural network model in which one or more of the parameters of the first neural network model are converted to zero.

In an embodiment of the disclosure, the memory 130 may store information about a plurality of neural network models. The neural network model may include a convolutional neural network (CNN) and a recurrent neural network (RNN). The neural network model may include a region-based CNN (R-CNN), a spatial pyramid pooling network (SPP-Net), You only look once (YOLO), a single-shot multibox detector (SSD), a deconvolutional single-shot multibox detector (DSSD), a long-short term memory (LTSM), a gated recurrent unit (GRU), or the like. The information about the plurality of neural network models may be stored in model parameter memory.

In an embodiment of the disclosure, the memory 130 may include a power consumption measurement module. The power consumption measurement module may include a temperature measurement device for a hardware chip in which the second processor 120 is implemented and a feedback circuit based on measurement results. The power consumption measurement module may include software, such as program codes, instructions, algorithms, and data structure executed by the first processor 110, so as to transfer a request to a user input to set a power consumption reduction mode for the second processor 120. In an embodiment of the disclosure, the first processor 110 may obtain a power consumption reduction request for the second processor 120 through the power consumption measurement module.

In an embodiment of the disclosure, the memory 130 may include a model regeneration module. The model regeneration module may be implemented as software, such as program codes, instructions, algorithms, or data structures executed by the first processor, so as to generate a low-power neural network model by applying a threshold value to parameters of the neural network model. In an embodiment of the disclosure, the first processor 110 may generate, through the model regeneration module, a second neural network model in which one or more of the parameters of the first neural network model are converted to zero.

In an embodiment of the disclosure, the memory 130 may include a profiling data database (DB). The profiling data DB may store profiling data, which is pre-analysis data on various types of neural network models. The profiling data may be collected and stored offline in the image processing apparatus 100. For example, the manufacturer of the profiling data may perform a test for adjusting weights and reducing power consumption while maintaining the performance of a neural network model. The profiling data may be used as information for understanding a trade-off relationship between the performance and power consumption of the neural network model. For example, the profiling data may include at least one of threshold value information for converting one or more of weights of the first neural network model to zero, quantitative evaluation information on the performance of a plurality of second neural network models in which one or more of the weights are converted to zero, qualitative evaluation information on the performance of the plurality of second neural network models, or power consumption reduction estimation information on the plurality of second neural network models. The memory 130 may store identified data from among the profiling data on the various types of neural networks stored in the profiling data DB. In an embodiment of the disclosure, the first processor 110 may obtain, through the profiling data DB, a threshold value of a parameter for converting one or more of the parameters within the first neural network model to zero. The profiling data DB may be stored in external memory.

In an embodiment of the disclosure, the first processor 110 may perform a computation on the second neural network model through the second processor 120 so as to obtain an output image from the input image through image processing.

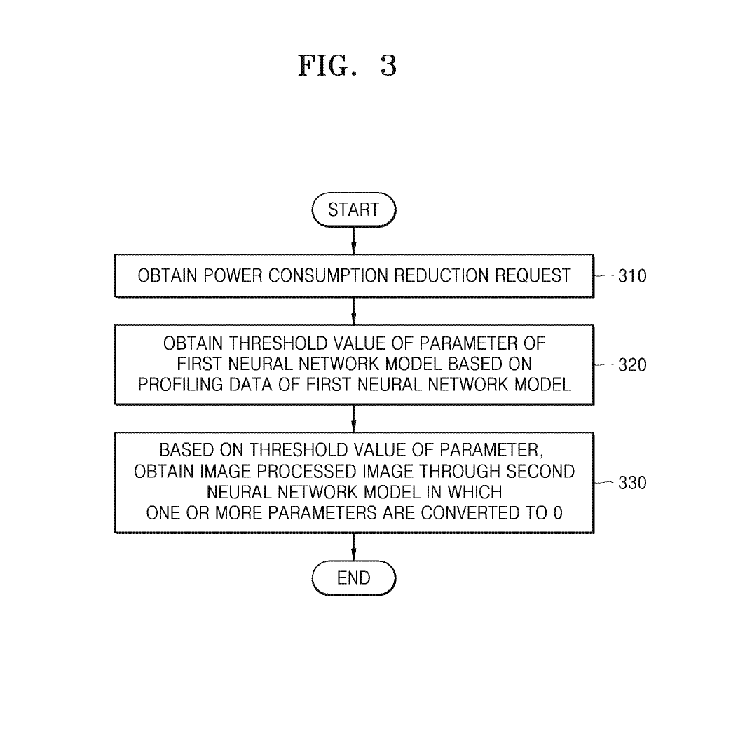

FIG. 3 is a flowchart for describing an operating method of the image processing apparatus, according to an embodiment of the disclosure.

Referring to FIG. 3, in operation 310, the image processing apparatus 100 may obtain a power consumption reduction request for the second processor 120.

In an embodiment of the disclosure, the image processing apparatus 100 may measure how much power consumption and heat generation should be reduced compared to the current state of the second processor 120, through the power consumption measurement module. For example, the power consumption measurement module may include a temperature measurement device for a hardware chip in which the second processor 120 is implemented and a feedback circuit based on measurement results. The image processing apparatus 100 may obtain a power consumption reduction request for the second processor 120 through the power consumption measurement module. The image processing apparatus 100 may set a target reduction amount corresponding to how much power consumption and heat generation should be reduced, based on the power consumption reduction request. Here, the target reduction amount may be at least one of the target power consumption reduction amount or the target heat generation reduction amount.

The image processing apparatus 100 may receive a user input to set a power consumption reduction mode. The power consumption reduction mode may provide a function for a user to set a desired power consumption reduction amount at a desired time. The image processing apparatus 100 may receive a power consumption reduction request based on the user input. The image processing apparatus 100 may set a target reduction amount based on the power consumption reduction amount desired by the user.

In operation 320, the image processing apparatus 100 may obtain, based on profiling data of a first neural network model, a threshold value of a parameter for converting one or more of parameters of the first neural network model to zero.

In an embodiment of the disclosure, the image processing apparatus 100 may access a profiling data DB when the power consumption reduction amount is received. The profiling data DB may store profiling data, which is pre-analysis data on various types of first neural network models. Here, the first neural network model may indicate a model in an initial state in which a neural network model corresponding to an algorithm processing algorithm is not low-powered. The first neural network model may be an initial model or a reference model for a second neural network model. The second neural network model may indicate a low-power neural network model in which one or more of the parameters of the first neural network model are converted. The profiling data DB may be stored in local memory of the image processing apparatus 100 or external memory.

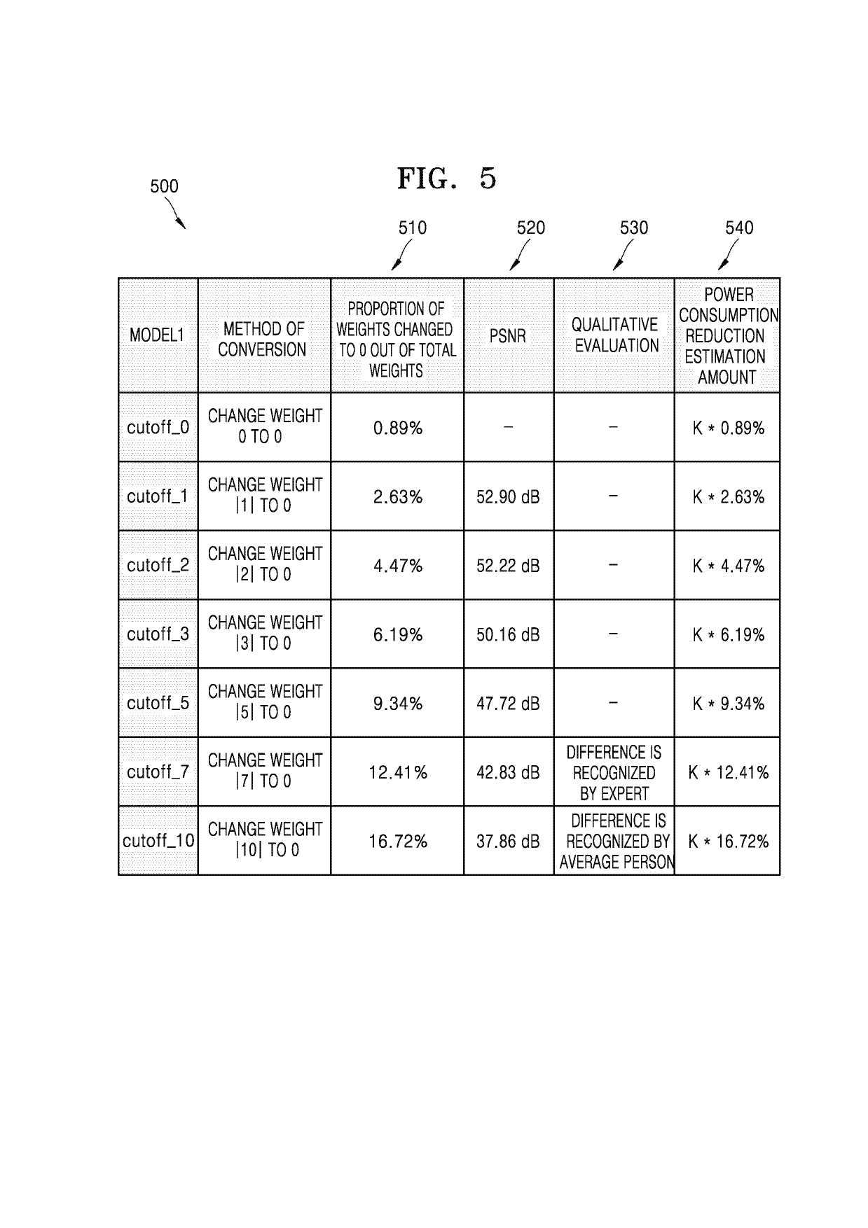

In an embodiment of the disclosure, the profiling data of the first neural network model may include threshold value information for converting one or more of the parameters of the first neural network model to zero, performance information on the second neural network model in which one or more of the parameters are converted to zero based on the threshold value, and power consumption reduction estimation information on the second neural network model. The performance information on the second neural network model may include at least one of quantitative evaluation information (e.g., peak signal-to-noise ratio (PSNR) in FIG. 5) on the performance of the second neural network models or qualitative evaluation information (e.g., whether the user has recognized, in FIG. 5) on the performance of the second neural network models. Descriptions of the profiling data are provided below with reference to FIGS. 5 to 7.

In an embodiment of the disclosure, the profiling data of the first neural network model may include information about a plurality of second neural network models in which weight ratios that are converted to zero vary depending on the threshold value. In the plurality of second neural network models, as a threshold value increases, a proportion of weights becoming 0 may increase, the performance of the neural network models may decrease, and a power consumption reduction estimation amount may increase. That is, the profiling data may indicate a relationship between the performance of the second neural network model, the amount of NPU computation, and the power consumption reduction amount, which vary depending on the proportion of the weight of the neural network model becoming 0. Here, the proportion of the weight becoming 0 may be inversely proportional to the amount of NPU computation and the power consumption. The amount of NPU computation and the power consumption may be proportional to each other. For example, as the proportion of the weight becoming 0 increases, the amount of NPU computation may increase and the power consumption may decrease. However, the disclosure is not limited thereto.

In an embodiment of the disclosure, the image processing apparatus 100 may obtain a threshold value of a parameter from the profiling data based on the target reduction amount. The image processing apparatus 100 may select an appropriate threshold value in consideration of a trade-off relationship between the performance and power consumption of the neural network model. For example, the image processing apparatus 100 may identify a threshold of any one second neural network model corresponding to the target reduction amount from the profiling data including the information about the plurality of second neural network models. For example, the image processing apparatus 100 may a threshold value of at least one second neural network model satisfying the minimum performance while having a power consumption reduction estimation amount corresponding to the target reduction amount. The performance of the second neural network model may be determined through at least one index from among qualitative evaluation performance and quantitative evaluation performance based on the performance of the first neural network model. The image processing apparatus 100 may identify a threshold value of at least one second neural network model capable of reducing power consumption and satisfying the minimum performance.

In addition, in an embodiment of the disclosure, the image processing apparatus 100 may determine based on the profiling data, whether to deactivate the first neural network model. In an embodiment of the disclosure, the profiling data DB may include profiling data for each of various types of first neural network models having different purposes. The profiling data DB may include information about the deactivation priority among the first neural network models. The image processing apparatus 100 may select a threshold value for reducing power consumption of the various types of first neural network models or determine whether to deactivate each of the first neural network models, based on the profiling data for each of the various types of first neural network models.

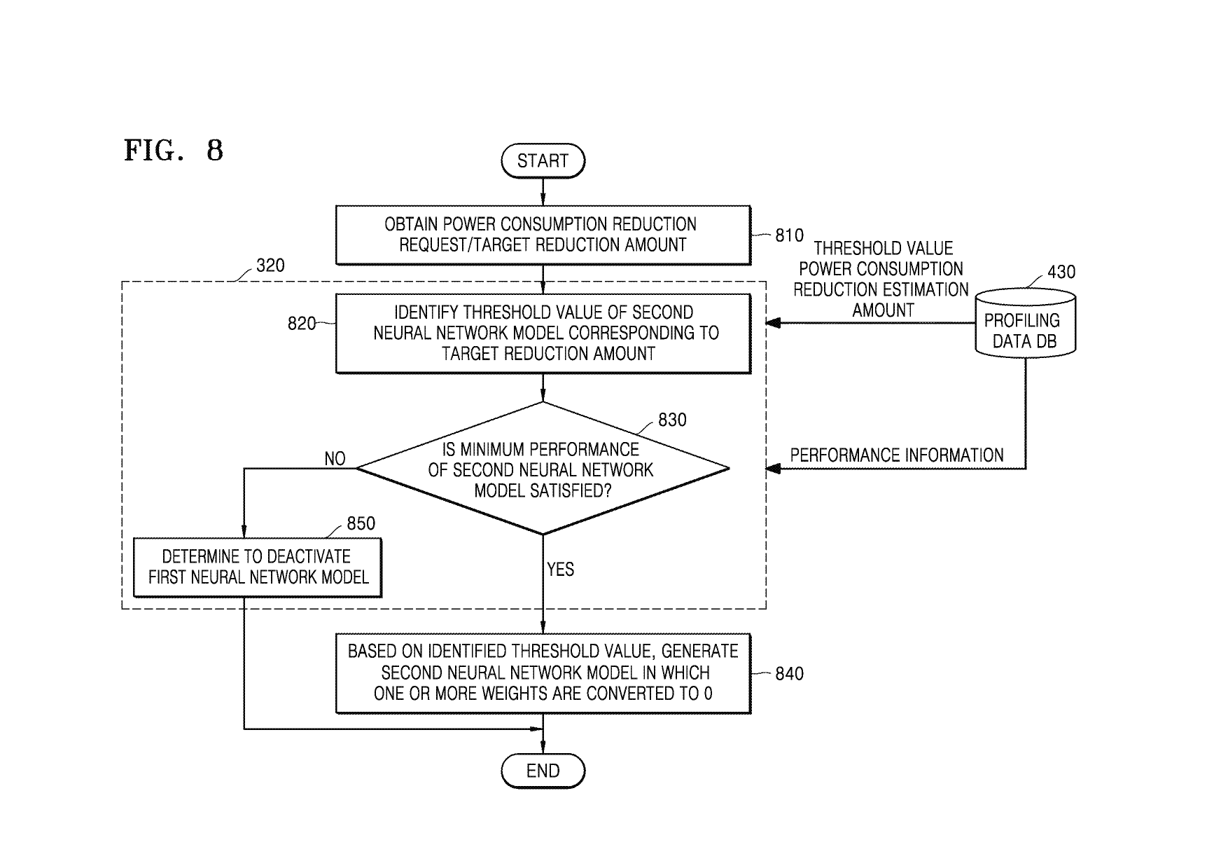

A method of obtaining a threshold value is further described with reference to FIGS. 8 to 10.

In operation 330, based on the threshold value of the parameter, the image processing apparatus 100 may obtain an image, which is an image obtained by performing image processing through the second neural network model in which one or more of the parameters is converted to zero.

The image processing apparatus 100 according to an embodiment of the disclosure may use the second neural network model in which the parameter within the threshold value range of the parameter of the first neural network model is converted to zero. The image processing apparatus 100 may generate an output image by performing image processing on an input image through the second neural network model, which is a low-power neural network model corresponding to the first neural network model.

The image processing apparatus 100 according to an embodiment of the disclosure may generate the second neural network model, which is a low-power neural network model, through a model regeneration module. For example, the image processing apparatus 100 may generate, through the model regeneration module, the second neural network model having a parameter in which a parameter within a threshold value range from among the initial parameters of the first neural network model is converted to zero. For example, the first processor 110 may transmit the generated second neural network model to the second processor 120. Here, transmitting the neural network model from the first processor 110 to the second processor 120 may indicate transmitting information about parameters of the neural network model. The second processor 120 may parameter information of the second neural network model rather than parameter information of the first neural network model. Here, the parameter information of the first neural network model may include information about the initial parameters of the first neural network model. The parameter information of the second neural network model may include information about a parameter in which a parameter within a threshold value range from among the initial parameters of the first neural network model is converted to zero. The second processor 120 may receive the input image and the parameter information of the second neural network model, and perform MAC computation based on the received input image and parameter information of the second neural network model. The image processing apparatus 100 may obtain an image-processed output image from the input image.

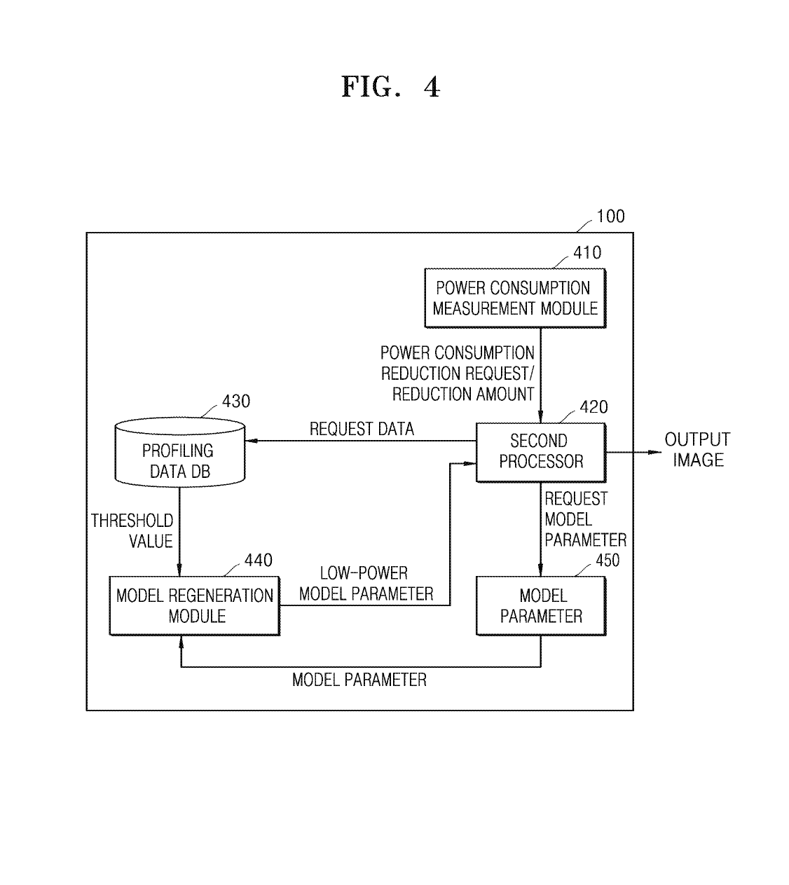

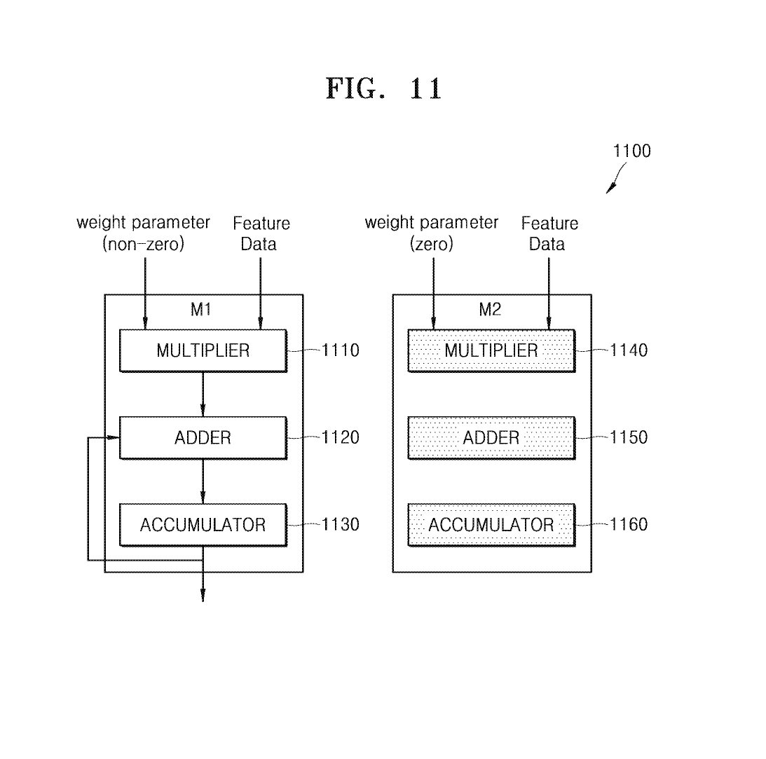

In this case, the second processor 120 according to an embodiment of the disclosure may include a first parameter identification circuit. The first parameter identification circuit may be a circuit configured to determine whether parameters input to the respective MAC operators is zero or non-zero, and when the parameter is zero, to control not to perform the operation of the corresponding MAC operator. The first parameter identification circuit may be provided in each of the plurality of MAC operators. The first parameter identification circuit may include clock gating circuitry configured to block a clock signal input to a MAC operator when the parameter input to the corresponding MAC operator is zero. For example, through the first parameter identification circuit, the second processor 120 may control not to perform an operation on a first MAC operator when a parameter input to the first MAC operator is non-zero, and control not to perform an operation on a second MAC operator when a parameter input to the second MAC operator is zero. Accordingly, the second processor 120 may skip a computation operation for parameters having a value of 0 in the second neural network model, thereby reducing unnecessary power consumption. This is described with reference to FIGS. 4 and 11.

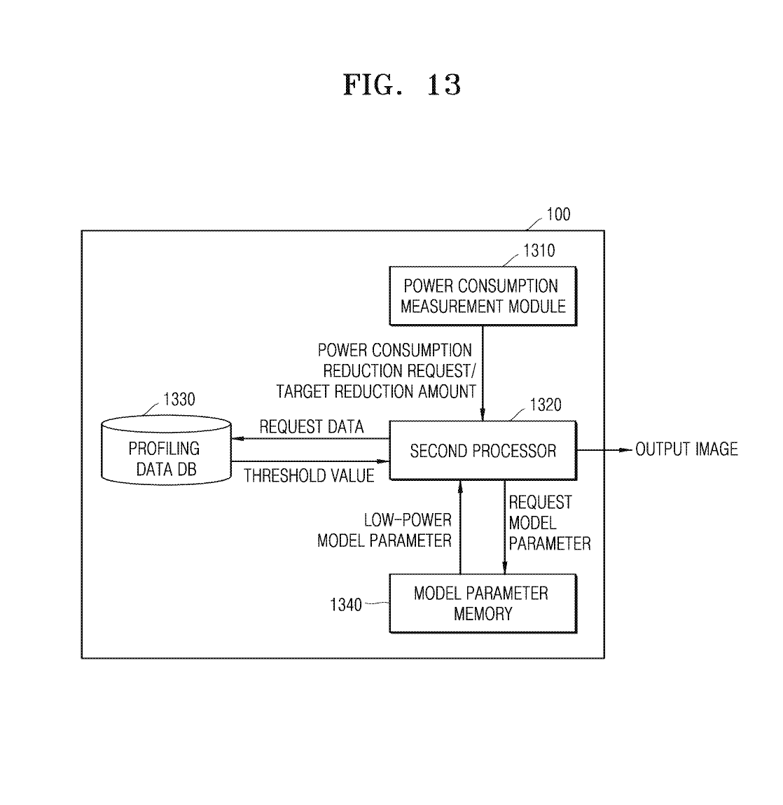

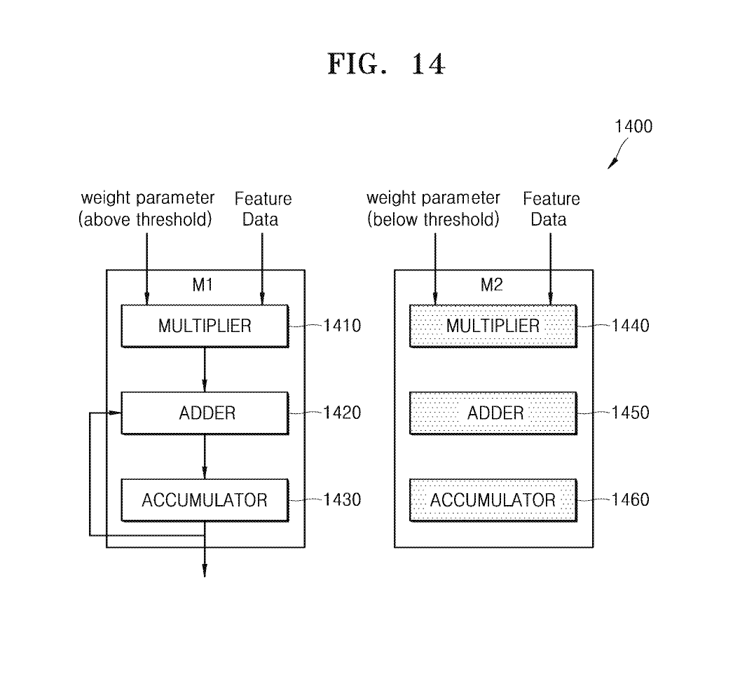

The first processor 110, according to an embodiment of the disclosure, may also transmit parameter information and threshold value information of the first neural network model to the second processor 120. The second processor 120 may parameter information of the first neural network model rather than parameter information of the second neural network model. In this case, the second processor 120 may apply a threshold value to the initial parameters of the first neural network model in real time. That is, the second processor 120 may perform, on the initial parameters of the first neural network model, the same computation as the computation performed on the second neural network model, by converting a parameter belonging to the threshold value range to zero or considering them as zero. To this end, the second processor 120 may include a second parameter identification circuit. The second parameter identification circuit may be a circuit configured to determine whether parameters input to the respective MAC operators belong to a threshold value range, and control not to perform an operation of the MAC operator when the parameter belongs to the threshold value range. The second parameter identification circuit may be provided in each of the plurality of MAC operators. The second parameter identification circuit may include clock gating circuitry configured to block a clock signal input to a MAC operator when a parameter input to the corresponding MAC operator is within a threshold value range. For example, through the second parameter identification circuit, the second processor 120 may perform an operation on the first MAC operator when parameters input to the first MAC operator is not within the threshold value range, and may not perform an operation on the second MAC operator when parameters input to the second MAC operator is within the threshold value range. This is described with reference to FIGS. 13 and 14. In this case, the image processing apparatus 100 may not include a model regeneration module, but the disclosure is not limited thereto.

In an embodiment of the disclosure, the image processing apparatus 100 may obtain the second neural network model with reduced power consumption from the first neural network model by using the model regeneration module and the first parameter identification circuit or by using the second parameter identification circuit, and may perform image processing on the input image through the second neural network model. Here, obtaining/generating the second neural network model may indicate obtaining/generating parameter information for the second neural network model. Performing computation for the second neural network model may indicate that a MAC operator receiving a parameter belonging to a threshold value range from among the initial parameters of the first neural network model does not perform computation. The image processing apparatus 100 may obtain an image-processed output image from the input image.

Meanwhile, in an embodiment of the disclosure, a threshold value of a parameter, a type of a neural network model to be reduced in power or deactivated, or a target reduction amount of the second processor 120 may be determined based on a user input. In this case, the image processing apparatus 100 may display a graphic user interface (GUI) for setting the threshold value of the parameter, the type of a neural network model to be reduced in power or deactivated, or the target reduction amount of the second processor 120.

In an embodiment of the disclosure, the image processing apparatus 100 may reduce power consumption of the second processor 120 that is used for computation of a neural network model while maintaining the performance of the neural network model. Accordingly, the power consumption of the second processor 120 may be reduced and the increase in heat generation may be reduced. The image processing apparatus 100 may reduce the power consumption of the neural network model by converting one or more of parameters to zero without additionally training, fine-tuning, or newly updating the first neural network model, which is a neural network model in an initial state.

FIG. 4 is a block diagram for describing an image processing operation by the image processing apparatus according to an embodiment of the disclosure.

Referring to FIG. 4, the image processing apparatus 100 according to an embodiment of the disclosure may include a power consumption measurement module 410, a second processor 420, and a model regeneration module 440. The image processing apparatus 100 may further include a profiling data DB 430 storing profiling data and model parameter memory 450 storing parameter information of a neural network model. However, not all of the elements shown are essential elements. The image processing apparatus 100 may be implemented by more elements than the shown elements, or may be implemented by fewer elements. In the disclosure, the term “module” may be implemented by executing software, such as program codes, instructions, algorithms, or data structures, stored in memory included in the image processing apparatus 100, by at least one first processor included in the image processing apparatus 100. Operations described below to be performed by a module of the image processing apparatus 100 may be actually performed by at least one first processor included in the image processing apparatus 100. The at least one first processor may correspond to the first processor 110 in FIG. 2. Here, the model parameter memory 450 may include double data rate (DDR) memory, but is not limited thereto.

The first processor 110 may measure through the power consumption measurement module 410, how much power consumption/heat generation reduction amount must be compared to the current state of the second processor 420. For example, the power consumption measurement module 410 may include a temperature measurement device for a hardware chip in which the second processor 120 is implemented and a feedback circuit based on measurement results. The power consumption measurement module 410 may include software, such as program codes, instructions, algorithms, and data structure executed by the first processor 110, so as to transfer a request to a user input to set a power consumption reduction mode. The first processor 110 may transmit a power consumption request and/or the measured target reduction amount to the second processor 420 through the power consumption measurement module 410.

The second processor 420 may receive the power consumption reduction request and/or the measured target reduction amount. The second processor 420 may request data stored in the profiling data DB 430 through the first processor 110. The second processor 420 may request model parameter information stored in the model parameter memory 450 through the first processor 110.

The first processor 110 may load profiling data stored in the profiling data DB 430. Based on the profiling data, the first processor 110 may identify a threshold value of a parameter for reducing power consumption of a neural network model. The first processor 110 may transmit the identified threshold value to the model regeneration module 440.

The model regeneration module 440 may receive the identified threshold value. The model regeneration module 440 may receive parameter information of a neural network model stored in the model parameter memory 450. The first processor 110 may generate a low-power neural network model through the model regeneration module 440 by applying the threshold value to the parameter of the neural network model and converting a parameter within a threshold value range to zero.

The first processor 110 may transmit the parameter information of the low-power neural network model to the second processor 420 through the model regeneration module 440. In addition, the first processor 110 may transmit the input image to the second processor 420. For example, in order to transmit the parameter information of the low-power neural network model, the first processor 110 may transmit, to the second processor 420, parameter information of a low-power neural network model to be processed by the second processor 420, or may transmit location of the memory (e.g., an address of the model parameter memory 450) to the second processor 420 so that the second processor 420 may access the parameter information. For example, the first processor 110 may transmit the location of memory in which an input image is stored to the second processor 420 so that the second processor 420 may access the input image.

The first processor 110 may transmit a neural network model execution command to the second processor 420, and the second processor 420 may load the input image and the parameter information from the memory to perform computation. For example, when a parameter of the low-power neural network model is zero, the second processor 420 may control not to perform an operation of the corresponding MAC operator, through the first parameter identification circuit. When the parameter of the low-power neural network model is non-zero, the second processor 420 may perform control such that an operation of the corresponding MAC operator is performed, through the first parameter identification circuit.

The second processor 420 may obtain, from the input image, an output image processed through a low-power neural network model. The second processor 420 may transmit the output image to the first processor 110. The first processor 110 may perform additional processing on the output image or output the output image through the display.

FIG. 5 is an example of profiling data of a first neural network model according to an embodiment of the disclosure.

Referring to FIG. 5, the profiling data may be stored in the form of a profiling table. Referring to a table 500, the first neural network model is shown, for example, as an upscaling model for high resolution (or super-resolution (SR) model). The upscaling model may be a neural network capable of converting a low-resolution image into a high-resolution image.

The rows of the table 500 indicate information about neural network models obtained by setting different threshold values (or ranges of threshold values) of weights. For example, a cutoff_n model may indicate a model in which weights within the range of a threshold value n are removed as a result of applying the threshold value n. For example, a cutoff_1 model may be a model in which the threshold value is set to 1, and weight values within ±1 are changed to zero. In the disclosure, a cutoff_0 model may be referred to as the first neural network model and the cutoff_n (except for n = 0) may be referred to as the second neural network model. The second neural network model may include a plurality of second neural network models to which different threshold values n are applied.

In the table 500, the first column indicates the names of neural network models, the second column indicates acquisition methods (i.e., weight changing methods) for the neural network models, a third column 510 indicates proportions of weights converted to zero from among the total weights, a fourth column 520 indicates PSNR, a fifth column 530 indicates qualitative evaluation, and a sixth column 540 indicates power consumption reduction estimation amounts.

Here, the weight ratio in the third column 510 may indicate a ratio of the number of weights converted to zero to the total number of weights of a neural network model.

Here, the PSNR in the fourth column 520 is an index indicating a difference between a reference image and a comparative image and may be used to quantitatively evaluate the performance of the upscaling model. For example, an output image generated through the cutoff_0 model may be the reference image. For example, an output image generated through the cutoff_n (except for n = 0) may be a comparative image for calculating a PSNR. A higher PSNR indicates that the quality of the comparative image is similar to that of the reference image, which may indicate that the high-resolution performance of the neural network model is high. A lower PSNR indicates that the quality of the comparative image is not similar to that of the reference image, which may indicate that the high-resolution performance of the neural network model is low. For example, when the PSNR is 50 dB or more, it may be considered that the image has a high similarity to the reference image. For example, when the PSNR is about 42 dB, the image quality may be qualitatively evaluated as being poor enough to be recognized by an expert. For example, when the PSNR is about 37 dB, the image quality may be qualitatively evaluated as being poor enough to be recognized by an average person. Here, the qualitative evaluation in the fifth column 530 may be determined by reflecting the quantitative evaluation indices of the fourth column 520.

Here, the power consumption reduction estimation amount in the sixth column 540 indicates a power consumption reduction amount of the second processor 120 that is estimated when each neural network model is calculated through the second processor 120. Ideally, the power consumption reduction estimation amount may be proportional to the proportion of weights changed to zero in the neural network model. In addition, the power consumption reduction estimation amount may be proportional to K. Here, K may indicate a power consumption amount used by a MAC operator performing neural network model computation from among the total power consumption amount. For example, in a case where the MAC operator uses 40 % to 60 % of the total power consumption amount of the second processor 120 when performing computation on a neural network model, K may be 40 % to 60 %. In the disclosure, the power consumption reduction estimation amount is expressed in a numerical value. However, the disclosure is not limited thereto, and the estimated power consumption reduction amount may be expressed in terms of a level, a ratio, a degree, or the like, in which case it may be referred to as “power consumption reduction estimation information”.

In the table 500, the cutoff_0 model is a model in which a threshold value is set to zero, and may be a model in which all zero values from among the weight values are changed to zero. That is, the cutoff_0 model may, in fact, indicate an initial model (or reference model) without modifying the weights. The cutoff_0 model may be a model in which 0.89 % of weights have a value of 0 (see the third column 510). The power consumption reduction estimation amount estimated through the cutoff_0 model may be K*0.89% (see the fifth column 540).

In the table 500, the cutoff_1 model is a model having a threshold value set to 1, and may be a model in which values between -1 and 1from among the weight values are all changed to zero. In the cutoff_0 model, the image processing apparatus may clip all weights having values between -1 and 1to zero. The cutoff_1 model may be a model in which 2.67 % of weights have a value of 0 (see the third column 510). For example, the PSNR indicating a difference between an output image generated through the cutoff_0 model (reference image) and an output image generated through the cutoff_1 model (comparative image) may be 52.90 dB (see the fourth column 520). The power consumption reduction estimation amount estimated through the cutoff_1 model may be K*2.67% (see the fifth column 540).

A weight ratio of the cutoff_1 model is a figure that has increased by 1.74 % compared to the cutoff_0 model, which means that 1.74 % of the total MAC computations are reduced, and K*1.74% of the total computations of the second processor 120 are reduced. The PSNR of the cutoff_1 model is 50 dB or more, which means it has a high similarity to the reference image, and the performed of the neural network model may be considered high.

In the table 500, a cutoff_7 model is a model having a threshold value set to 7, and may be a model in which values between -7and7 from among the weight values are all changed to zero. The cutoff_7 model may be a model in which 12.41 % of weights have a value of 0 (see the third column 510). For example, the PSNR of the cutoff_7 model may be 42.83 dB (see the fourth column 520). The power consumption reduction estimation amount estimated through the cutoff_7 model may be K*12.41% (see the fifth column 540).

In the case of the cutoff_7 model, 12.41 % of the total parameters are clipped to zero, and compared to the cutoff_0 model (initial model), at least 10 % of the total MAC computations do not operate, and proportionally, the total computations of the second processor 120 may be reduced by at least 10 %. However, in the case of the cutoff_7 model, the PSNR is 42.83 dB, which means there is a quality difference that can only be recognized at the expert level (see the fourth column 530).

In the table 500, a cutoff_10 model is a model having a threshold value set to 10, and may be a model in which values between -10 and 10 from among the weight values are all changed to zero. The cutoff_10 model may be a model in which 16.72 % of weights have a value of 0 (see the third column 510). For example, the PSNR of the cutoff_10 model may be 37.86 dB (see the fourth column 520). The power consumption reduction estimation amount estimated through the cutoff_10 model may be K*16.72% (see the fifth column 540). In the case of the cutoff_10 model, the PSNR is 37.86 dB, which means there is a quality difference that can be recognized even by an average person (see the fourth column 530).

The table 500 shows information about the cutoff_1 model to the cutoff_10 model as the second neural network model. As the threshold value n used in cutoff_n increases, the proportion of weights changed to zero (see the third column 510) may increase, the PSNR see the fourth column 520) may decrease, and the power consumption reduction estimation amount (see the fifth column 540) may increase. Descriptions of cutoff_2 to cutoff_5 are similar to those of the cutoff_1 model provided above. Accordingly, for additional implementation details, reference may be made to the descriptions of the cutoff_1 model.

The profiling data of the first neural network model may include information about a threshold value used in each cutoff stage of the first neural network model, a weight changing method, the proportion of weights changed to zero from among the total weights, the PSNR, which is a quantitative evaluation index of performance of an upscaling model, whether a user has recognized, which is a qualitative evaluation index of performance of the upscaling model, and the power consumption reduction estimation amount. However, the disclosure is not limited thereto, and at least one piece of information of the information described above may be omitted in the profiling data of the first neural network model.

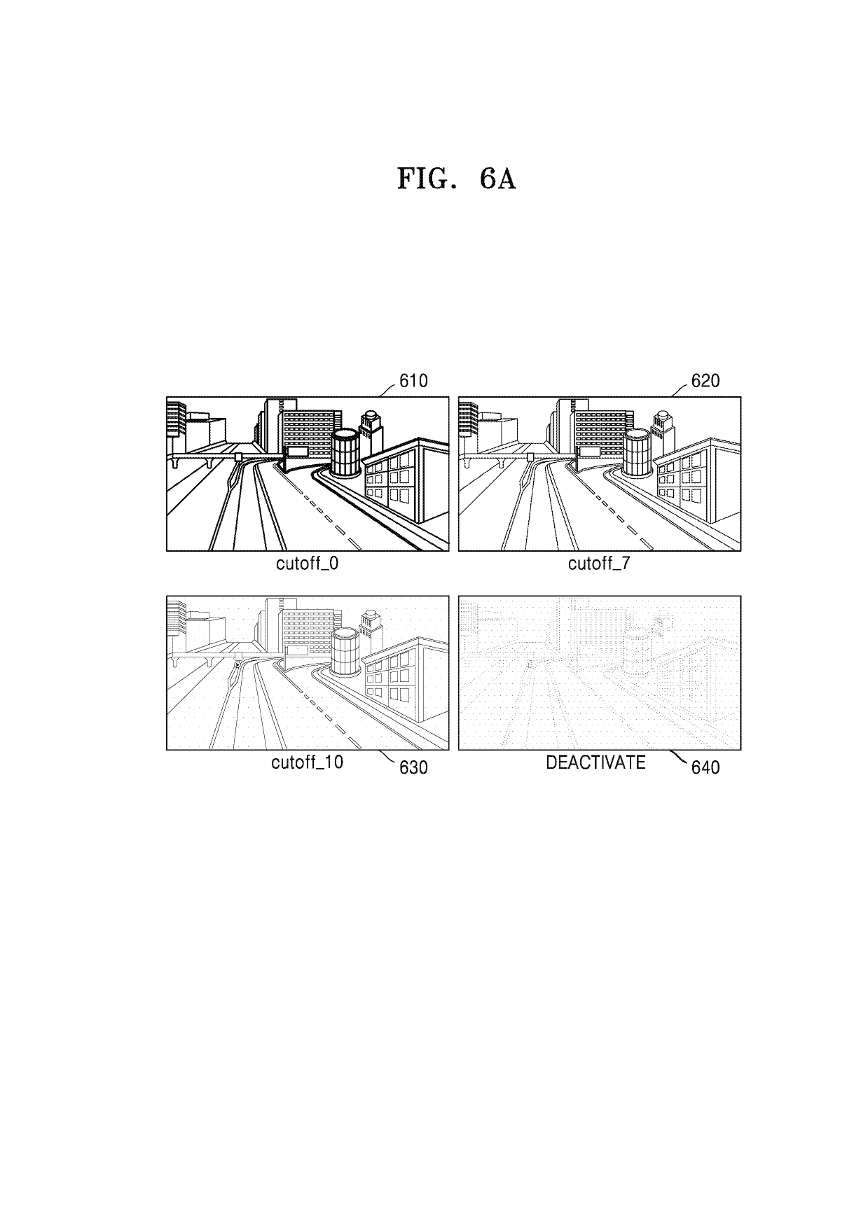

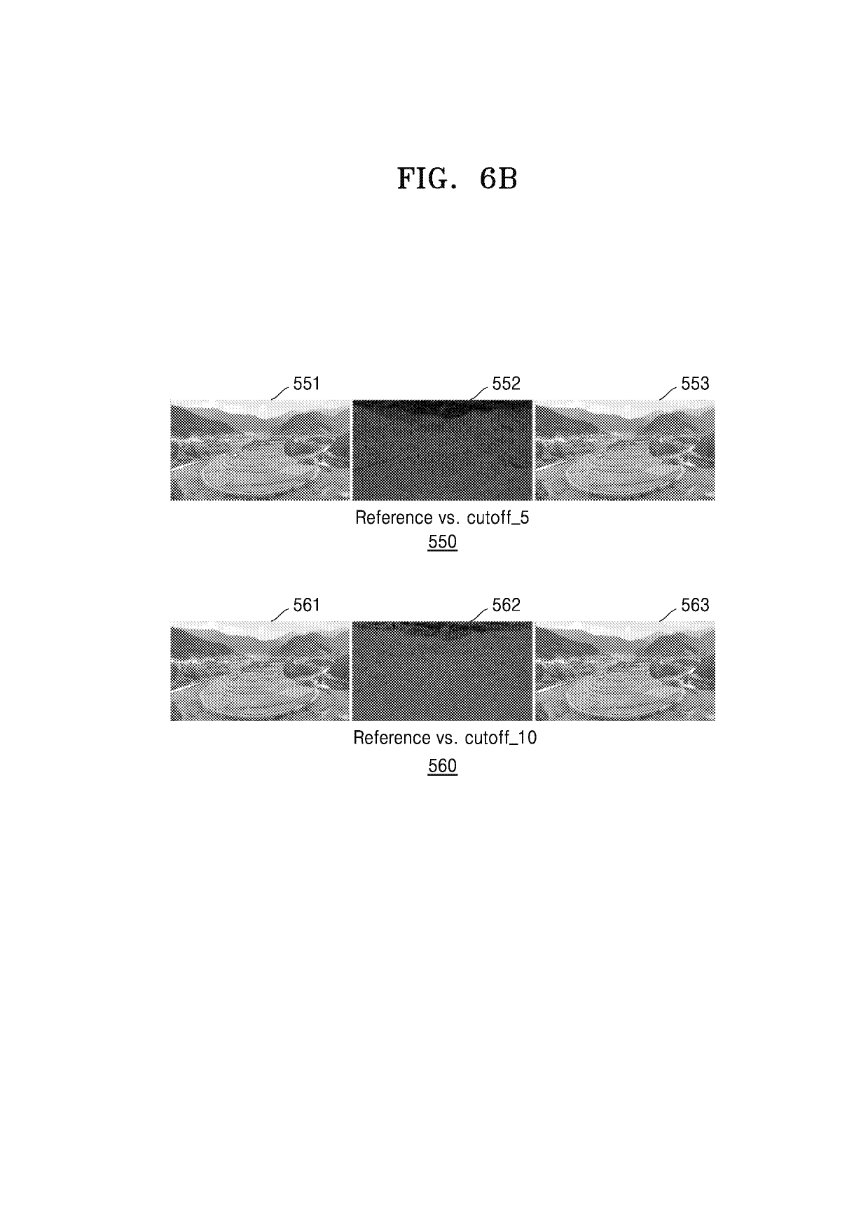

FIG. 6A shows examples of output images for qualitative evaluation of neural network models in the profiling data in FIG. 5.

In FIG. 6A, an output image 610 of the cutoff_0 model, an output image 620 of the cutoff_7 model, an output image 630 of the cutoff_10 model, and an image 640 when the neural network model is deactivated. The main difference may be in the clarity of the diagonal components of the building roof. Based on the output image 610 of the cutoff_0 model, a similar level of high-resolution performance may be shown up to the output image 620 of the cutoff_7 model. However, in the case of the output image 630 of the cutoff_10 model, it can be seen that the power consumption reduction amount increases, but the clarity decreases, as in the image 640 when the neural network model is deactivated. That is, when the cutoff_7 model is used, it may be more effective in terms of power consumption to reduce power consumption of the upscaling model. However, when the cutoff_10 model is used, it may be more effective in terms of power consumption to deactivate the upscaling model. That is, when the cutoff_10 model is used, because there is a quality difference that may be recognized even by an average person (see the fourth column 530 in FIG. 5), the image processing apparatus may determine to deactivate the upscaling function itself rather than using the cutoff_10 model to reduce power consumption.

FIG. 6B shows examples of output images for quantitative evaluation of neural network models through peak signal-to-noise ratio in the profiling data in FIG. 5. In 550 in FIG. 6B, a reference image 551 corresponding to an output image of the cutoff_0 model, a comparative image 553 corresponding to an output image of the cutoff_5 model, and a difference image 552 indicating a difference between the reference image 551 and the comparative image 553 are shown. In 560 in FIG. 6B, a reference image 561 corresponding to an output image of the cutoff_0 model, a comparative image 563 corresponding to an output image of the cutoff_10 model, and a difference image 562 indicating a difference between the reference image 561 and the comparative image 563 are shown. In the difference image 552 and the difference image 562, when the difference in pixel values is greater than 2, the images are displayed as a first color (e.g., red), and when the difference in pixel values is less than 2, the images are displayed as a second color (e.g., blue) that is different from the first color.

Referring to the difference image 552 in FIG. 6B, a difference between the reference image 551 of the cutoff_0 model and the comparative image 553 of the cutoff_5 model may be relatively small. However, referring to the difference image 562 in FIG. 6B, the difference between the reference image 561 of the cutoff_0 model and the comparative image 563 of the cutoff_10 model may be relatively large. For example, referring to the fourth column 520 in FIG. 5, the PSNR of the cutoff_10 model may be as low as 37.86 dB.

That is, when the cutoff_5 model is used, it may be more effective in terms of power consumption to reduce power consumption of the upscaling model. However, when the cutoff_10 model is used, it may be more effective in terms of power consumption to deactivate the upscaling model. That is, the image processing apparatus may determine to deactivate the upscaling function itself rather than using the cutoff_10 model to reduce power consumption.

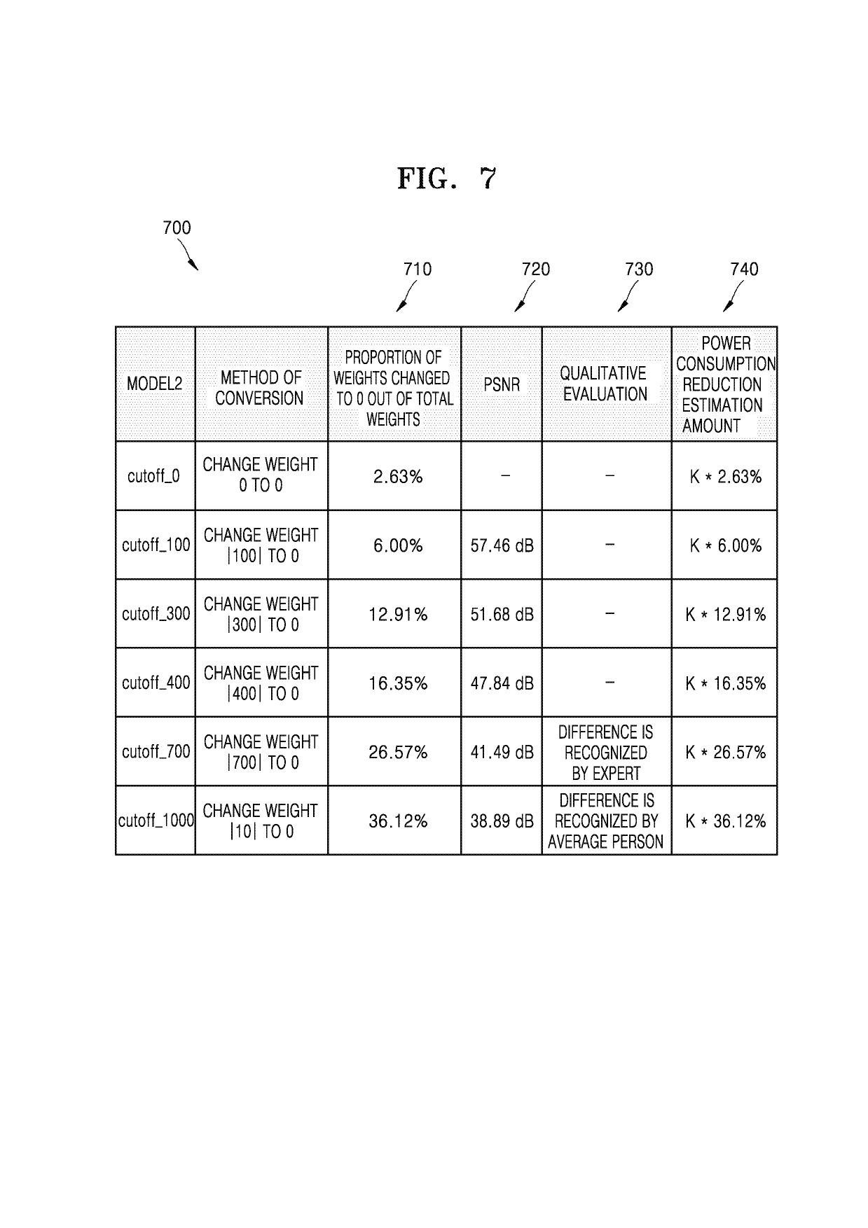

FIG. 7 is an example of profiling data of the first neural network model according to an embodiment of the disclosure. Features described with respect to FIG. 7 may overlap with the features described with respect to FIG. 5. Accordingly, for additional implementation details, reference may be made to the descriptions of FIG. 5.

The profiling data shown in FIG. 7 may be profiling data for the first neural network model (also referred to as “model 2”) that is different from the first neural network model (also referred to as “model 1”) shown in FIG. 5. The profiling data may exist for each of a plurality of first neural network models of various types. The profiling data may vary depending on the type, characteristics, or purpose of a trained neural network model. For example, upscaling models trained by using different training data may have different profiling results even when the upscaling models have the same upscaling purpose. This is because parameter distributions of neural network models are different.

In the table 700, the cutoff_0 model may be a model in which 2.63 % of weights have a value of 0 (see a third column 710). The power consumption reduction estimation amount estimated through the cutoff_0 model may be K*0.89% (see a fifth column 740).

In the table 700, a cutoff_100 model is a model having a threshold value set to 100, and may be a model in which values between -100 and 100 from among the weight values are all changed to zero. The cutoff_100 model may be a model in which 6.00 % of weights have a value of 0 (see the third column 710). For example, the PSNR indicating a difference between an output image generated through the cutoff_0 model (reference image) and an output image generated through the cutoff_100 model (comparative image) may be 57.46 dB (see a fourth column 720). The power consumption reduction estimation amount estimated through the cutoff_100 model may be K*6.00% (see the fifth column 740).

The table 700 shows information about the cutoff_100 model to the cutoff_1000 model as the second neural network model. Descriptions of cutoff_300 to cutoff_1000 are similar to those of the cutoff_100 model provided above. Accordingly, for additional implementation details, reference may be made to the descriptions of the cutoff_100 model.

The profiling data of the first neural network model may include information about a threshold value used in each cutoff stage of the first neural network model, a weight changing method, the proportion of weights changed to zero from among the total weights, the PSNR, which is a quantitative evaluation index of performance of an upscaling model, whether a user has recognized, which is a qualitative evaluation index of performance of the upscaling model, and the power consumption reduction estimation amount. However, the disclosure is not limited thereto, and at least one piece of information of the information described above may be omitted in the profiling data of the first neural network model.

FIG. 8 is a flowchart of a method by which an image processing apparatus according to an embodiment of the disclosure obtains a threshold value for the first neural network model.

Referring to FIG. 8, in operation 810, the image processing apparatus 100 may obtain a target reduction amount together with a power consumption reduction request. For example, as described with reference to operation 310, the image processing apparatus 100 may measure how much power consumption and heat generation should be reduced compared to the current state of the second processor 120, through the power consumption measurement module. In the image processing apparatus 100, a device for setting a power consumption reduction mode may receive a power consumption reduction request and/or a target reduction amount based on a user input. Here, the target reduction amount may indicate a power consumption reduction amount requested or set through a power consumption reduction request module or a user input.

In operation 820, the image processing apparatus 100 may identify a threshold value of a second neural network model corresponding to the target reduction amount based on the profiling data of the first neural network model.

For example, the image processing apparatus 100 may identify a threshold value of each of the plurality of second neural network models and a power consumption reduction estimation amount of each of the plurality of second neural network models, included in the profiling data of the first neural network model. The image processing apparatus 100 may identify a threshold value of the second neural network model having a power consumption reduction estimation amount corresponding to the target reduction amount. Here, when the power consumption reduction estimation amount corresponds to the target reduction amount (e.g., P), it indicates not only that the power consumption reduction estimation amount is equal to the target reduction amount, but also that the power consumption reduction estimation amount is equal to a certain proportion (e.g., 10 % of P) of the target reduction amount. For example, when the target reduction amount is P, the image processing apparatus 100 may identify a threshold value for reducing P by 100 %, ,or may identify a threshold value for reducing P by 10 % through the first neural network model.

In operation 830, the image processing apparatus 100 may identify a threshold value of the second neural network model satisfying the minimum performance from among the plurality of second neural network models.

Here, the minimum performance may refer to the minimum performance that the low-power second neural network model must have when compared to the performance of the first neural network model, which is the model in the initial state. Here, the minimum performance of the second neural network model may be determined through indices, such as qualitative evaluation performance and quantitative evaluation performance. When the performance of the second neural network model does not reach conditions preset by the manufacturer of the image processing apparatus 100, it may be more effective in terms of power consumption to deactivate the first neural a network model rather than reducing the first neural network model. For example, in the table 500 of FIG. 5, and FIGS. 6A and 6B, the power consumption reduction amount of the cutoff_10 model (e.g., K*16.72%) corresponds to the target reduction amount, but when the PSNR is less than a certain value (e.g., 37.86 dB), it is considered that the minimum performance is not satisfied, and the first neural network model may be deactivated. For example, in the case of an upscaling model, the minimum performance of the upscaling model may be a PSNR greater than a certain value.

For example, the image processing apparatus 100 may identify whether the second neural network model having the threshold value identified through operation 820 satisfies the minimum performance. From among the threshold values of the plurality of second neural network models, the image processing apparatus 100 may identify a threshold value of a second neural network in which the PSNR is greater than the certain value and the power consumption reduction estimation amount corresponds to the target reduction amount. However, the disclosure is not limited thereto, and operations 820 and 830 may operate separately.

In operation 840, when the identified second neural network model satisfies the minimum performance, the image processing apparatus 100 may generate, based on the identified threshold value of the second neural network model, a second neural network model in which one or more of weights of the first neural network model are converted to zero.

In operation 850, when the identified second neural network model does not satisfy the minimum performance, the image processing apparatus 100 may deactivate the first neural network model without converting the first neural network model to the second neural network model.

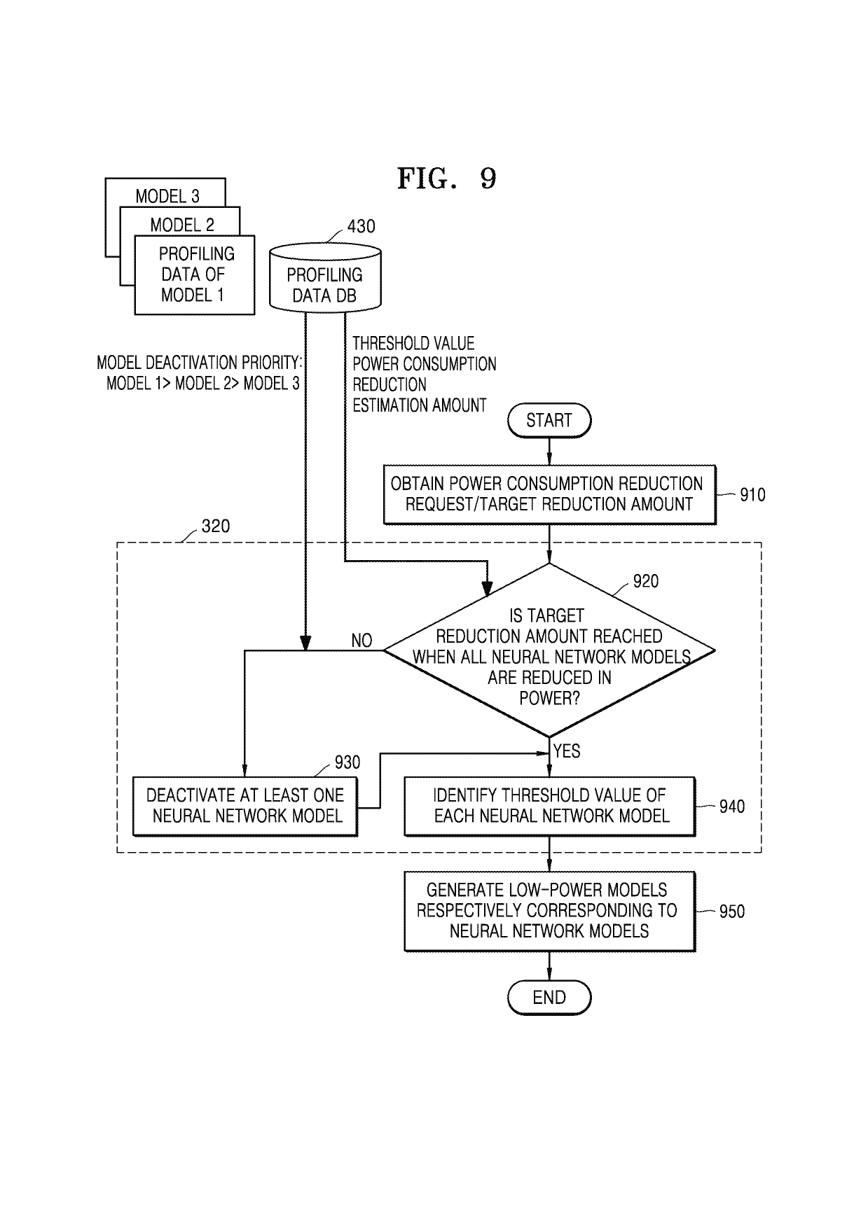

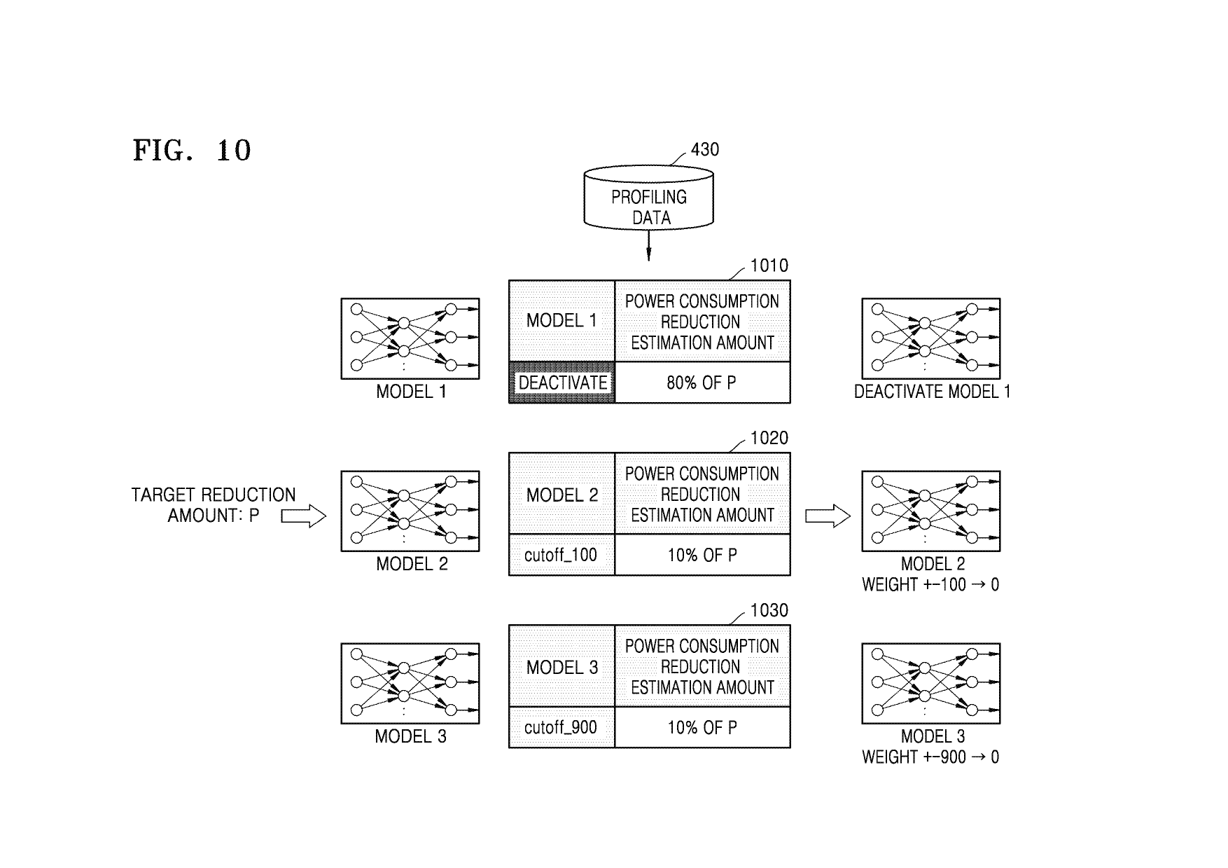

FIG. 9 is a flowchart of a method by which an image processing apparatus according to an embodiment of the disclosure obtains a threshold value for each of a plurality of first neural network models. FIG. 10 shows an example of an operation of determining, by an image processing apparatus according to an embodiment of the disclosure, power reduction or deactivation of the plurality of first neural network models.

Referring to FIG. 9, in operation 910, the image processing apparatus 100 may obtain a target reduction amount together with a power consumption reduction request. Operation 910 may correspond to operation 810 in FIG. 8.

In operation 920, the image processing apparatus 100 may determine whether the target reduction amount may be reached when all operating neural network models are reduced in power. The image processing apparatus 100 may use the profiling data of each of the neural network models in the determination process of operation 920. The image processing apparatus 100 according to an embodiment of the disclosure may reduce power consumption of or deactivate each of the plurality of first neural network models by using the profiling data of each of various types of first neural network models.

The image processing apparatus 100 according to an embodiment of the disclosure may use various types of first neural network models having different purposes for image processing. The image processing apparatus 100 may divide and allocate limited resources of the second processor 120 to the various types of first neural network models, and power consumption may increase during a computation process for the various types of first neural network models.

The profiling data according to an embodiment of the disclosure may include profiling tables for each of a plurality of first neural network models of various types (e.g., model 1, model 2, and model 3). Each of the profiling tables may include information (e.g., threshold values, weight ratios, PSNR, and power consumption reduction estimation amounts) about a plurality of second neural network models in which one or more of weights are converted to zero corresponding to a particular first neural network model. For example, the image processing apparatus 100 may identify profiling data including information indicating a threshold value of the plurality of second neural network models corresponding to each of a plurality of first neural network models.

In operation 930, when it is determined that the target reduction amount cannot be satisfied even when all of various types of first neural network models are reduced in power, the image processing apparatus 100 may deactivate at least one first neural network model from among the various types of first neural network models. In this case, a priority for deactivation may be determined among the various types of plurality of first neural network models, and the profiling data may store information about a deactivation priority among the various types of first neural network models. For example, the profiling data designates deactivation priorities in the order of model 1, model 2, and model 3, the image processing apparatus 100 may deactivate model 1.

In operation 940, when it is determined that the target reduction amount may be reached when all operating neural network models are reduced in power, the image processing apparatus 100 may identify a threshold value for reducing power consumption of each of the neural network models. In operation 950, the image processing apparatus 100 may generate a low-power neural network model respectively corresponding to the identified neural network models.

Referring to FIG. 1, for example, it is assumed that the requested target reduction amount is P. It is assumed that the profiling data DB 430 stores profiling data 1010 of model 1 (e.g., an upscaling model), profiling data 1020 of model 2 (e.g., an FRC model), and profiling data 1030 of model 3 (e.g., a contrast enhancement (CE) model). It is assumed that the profiling data 1010 of model 1 stores information indicating that 80 % of P is reduced when model 1 is deactivated. It is assumed that the profiling data 1020 of model 2 stores information indicating that 10 % of P is additionally reduced when the threshold value of model 2 is set to 100. It is assumed that the profiling data 1030 of model 3 stores information indicating that 10 % of P is additionally reduced when the threshold value of model 3 is set to 900. In this case, the image processing apparatus 100 may determine to deactivate model 1, determine that the threshold value of the model 2 is 100, and determine that the threshold value of model 3 is 900. Accordingly, the image processing apparatus 100 may deactivate model 1. The image processing apparatus 100 may convert weights within the threshold value ±100 to zero for model 2. The image processing apparatus 100 may convert weights within the threshold value ±900 to zero for model 3.

Meanwhile, according to operation 830 in FIG. 8, the image processing apparatus 100 may additionally identify whether the neural network model reduced in power satisfies the minimum performance for each of the plurality of first neural network models. For example, it may be identified whether a PSNR of model 1, which is an upscaling model, is greater than a certain value (e.g., 37.86 dB).

The image processing apparatus 100 according to an embodiment of the disclosure may obtain a threshold value of parameters of each of the various types of plurality of first neural network models based on the profiling data of each of the plurality of first neural network models. The image processing apparatus 100 may generate each of a plurality of second neural network models corresponding to the parameter threshold value of each of the plurality of first neural network models, and perform image processing through the second neural network models, thereby reducing power consumption.

FIG. 11 is a block diagram for describing an operator and a first parameter identification circuit of a second processor according to an embodiment of the disclosure.

FIG. 11 shows a first MAC operator (“M1” in FIG. 11) and a second MAC operator (“M2” in FIG. 11) included in an operator 1100 of the second processor according to an embodiment of the disclosure. The first MAC operator and the second MAC operator may be connected in parallel with each other. Here, the second processor may correspond to the second processor 420 in FIG. 4.

A weight parameter and feature data may be input to each of the first MAC operator and the second MAC operator. The weight parameter and the feature data may have a certain number of bits. Each MAC operator may perform computation on a certain number of weights. For example, one MAC operator may process eight weights. The certain number may vary depending on the time required for computation per MAC operator and system limitations. The feature data may indicate a value stored in each node within a layer of a neural network model, but is not limited thereto.

The first MAC operator may include a multiplier 1110, an adder 1120, and an accumulator 1130. However, the disclosure is not limited thereto. The second MAC operator may include a multiplier 1140, an adder 1150, and an accumulator 1160. However, the disclosure is not limited thereto. For example, in the first MAC operator, the multiplier 1110 may multiply an input weight parameter and feature data, and the adder 1150 and the accumulator 1160 may accumulate the computation values input from the multiplier 1110.

Each MAC operator included in the operator 1100 may include a first parameter identification circuit. The first parameter identification circuit may determine whether a parameter input to each MAC operator is zero or non-zero. Based on the determination result, the first parameter identification circuit may control the MAC operator that has received the corresponding parameter to perform computation only when the parameter value is non-zero. The first parameter identification circuit may control the MAC operator that has received the corresponding parameter to not perform the computation operation, when the parameter value is zero.

For example, the first parameter identification circuit may include clock gating circuitry configured to block clock signals for the MAC operator that has received a parameter corresponding to zero. For example, when the input weight value is non-zero, the first MAC operator may perform computation on the neural network model based on the input weight value and feature data. For example, the second MAC operator may not perform computation on the neural network model when the input weight value is non-zero. That is, when the weight value input to the multiplier is zero, the result is zero even when the weight and the feature data are multiplied. Therefore, the second processor may control the MAC operator to not perform a computation operation, by using the first parameter identification circuit. Accordingly, the second processor may not perform an unnecessary computation of multiplying by zero and adding zero, thereby preventing unnecessary power consumption. In addition, unnecessary increases in heat generation directly proportional to power consumption may be prevented.

Meanwhile, in the second processor according to an embodiment of the disclosure, a method of distinguishing a parameter that is zero by using mask bits may be used. The mask bits may be bits indicating whether each weight parameter is zero or non-zero. For example, when the number of weights is more than one, mask bits respectively corresponding to the weights may be used. For example, when the value of a mask bit is one, it may indicate that the weight is not zero, and when the value of the mask bit is zero, it may indicate that the weight is zero. For example, when it is assumed that there are four weights w0, w1, w2, and w3, the size of the mask may be 4 bits. When the mask bits are 1011 in binary, it may indicate that w0, w2, and w3 are 1, and w1 may be 0. Accordingly, it may be determined whether the weight is zero by using the mask bit value. In a method of distinguishing a parameter that is zero by using a mask bit, there is no need for the second processor to have hardware such as the first parameter identification circuit, and thus a general-purpose NPU may be used. However, because the number of mask bits equal to the number of weight parameters are required, the size of data that must be stored in the second processor may increase. As the neural network model gets more complex, the number of weight parameters used increases, and thus the usability of the method of using mask bits may decrease.

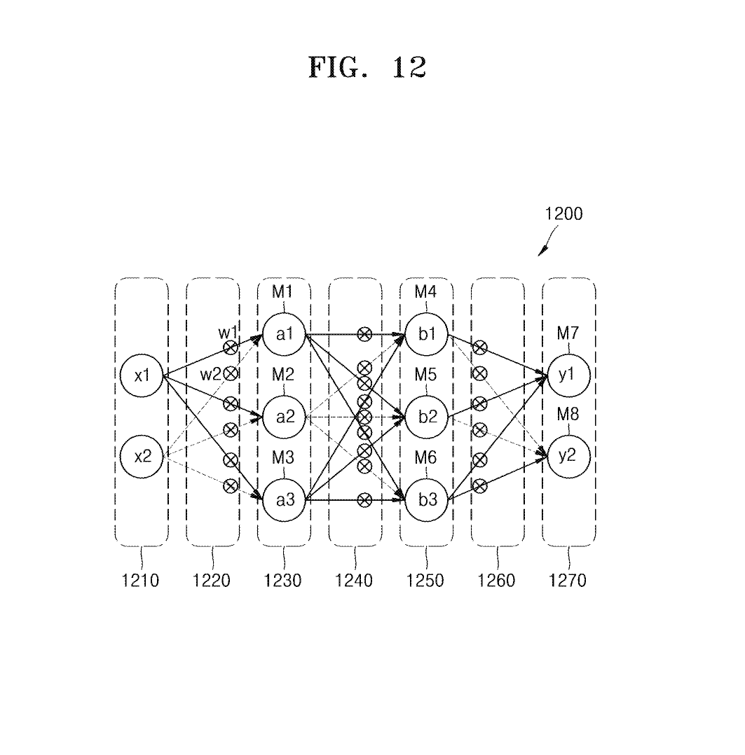

FIG. 12 is a diagram for describing a neural network model that is computed in the second processor according to an embodiment of the disclosure.

FIG. 12 shows an example of a structure of a neural network model 1200. The neural network model 1200 may perform an inference operation through a computation process of the second processor. Here, a result of the inference operation of the neural network model 1200 may be an output image that is image-processed from an input image to suit each purpose of an image processing algorithm.

The neural network model 1200 may be a deep neural network (DNN) model including an input layer 1210, a first connection network 1220, a first hidden layer 1230, a second connection network 1240, a second hidden layer 1250, a third connection network 1260, and an output layer 1270. However, the disclosure is not limited thereto.

The input layer 1210 may include an x1 input node and an x2 input node. The input layer 1210 may include information about two input values.

The first connection network 1220 may include information about six weight values for connecting each node of the input layer 1210 to each node of the first hidden layer 1230. Each weight value may be multiplied by an input node value, and the accumulated sum of the multiplied values may be stored in the first hidden layer 1230. The weight value and the input node value may each be referred to as parameters of the neural network model 1200.

The first hidden layer 1230 may include an a1 node, an a2 node, and an a3 node. The first hidden layer 1230 may include information about three node values. Here, the first MAC operator M1 may process the computation of the a1 node. The second MAC operator M2 may process the computation of the a2 node. The third MAC operator M3 may process the computation of the a3 node. For example, the a1 node may store the sum of an input value stored in the x1 input node multiplied by the weight value w1 and an input value stored in the x2 input node multiplied by the weight value w2.

The second connection network 1240 may include information about nine weight values for connecting each node of the first hidden layer 1230 to each node of the second hidden layer 1250. The weight values of the second connection network 1240 may each be multiplied by the node values input from the first hidden layer 1230, and the accumulated value of the multiplied values is stored in the second hidden layer 1250.

The second hidden layer 1250 may include, for example, b1, b2, and b3 nodes. That is, the second hidden layer 1250 may include information about three node values. Here, the fourth MAC operator M4 may process the computation of the b1 node. The fifth MAC operator M5 may process the computation of the b2 node. The sixth MAC operator M6 may process the computation of the b3 node.

The third connection network 1260 may include, for example, information about six weight values that connect each node of the second hidden layer 1250 and each node of the output layer 1270. The weight values of the third connection network 1260 may each be multiplied by the node values input from the second hidden layer 1250, and the accumulated value of the multiplied values is stored in the output layer 1270.

The output layer 1270 may include, for example, y1 and y2 nodes. That is, the output layer 1270 may include information about two node values. Here, the seventh MAC operator M7 may process the computation of the y1 node. The eighth MAC operator M8 may process the computation of the y2 node.

The image processing apparatus 100 according to an embodiment of the disclosure may perform image processing on the second neural network by converting a weight having a value within a threshold value range to zero. For example, the first MAC operator M1 may not perform the computation of the a1 node when the weight value w1 and the weight value w2 are zero. In this case, the image processing apparatus 100 may generate, through the model regeneration module, a neural network model in which the weight value having an initial weight value within the threshold value range is converted to zero, and transmit, to the second processor, parameter information about the neural network model converted to zero. The second processor may include a first parameter identification circuit.

The first MAC operator M1 may not perform the computation of the a1 node when the weight value w1 and the weight value w2 are within the threshold value range. In this case, the image processing apparatus 100 may transmit, to the second processor, information indicating a threshold value and parameter information including the initial weight value of the neural network model. The second processor may include a second parameter identification circuit.

Meanwhile, when the neural network model 1200 is a convolution neural network (CNN) that performs a convolution operation, the neural network model 1200 may generate an output image from an input image through a convolution computation operation process of the second processor. For example, the input image may be displayed in a two-dimensional matrix, which includes rows of a specific size and columns of a specific size. The input image may have a plurality of channels, and the channels may indicate the number of color components of the input image (e.g., three for R, G, B). The convolution operation process may be traversing the input image at designated intervals and performing a convolution operation with a kernel. A convolution neural network may have a structure for transmitting an output value (convolution) of a current layer to an input layer of the next layer. For example, the convolution may be defined by two parameters (e.g., an input feature map and a kernel). The parameters may include input feature map, an output feature map, an activation map, weights, kernel, and attention (Q, K, V). Convolution may be described as sliding a kernel window over an input feature map. The step size by which the kernel slides the input feature map may be referred to as a stride. Even in this case, the MAC operators of the second processor may be used to process each convolution. Even in this case, the image processing apparatus 100 according to an embodiment of the disclosure may perform image processing on the second neural network by converting elements of a kernel having values within a threshold value range to zero.

FIG. 13 is a block diagram for describing an image processing operation by the image processing apparatus according to an embodiment of the disclosure.

Referring to FIG. 13, the image processing apparatus 100 according to an embodiment of the disclosure may include a power consumption measurement module 1310 and a second processor 1320. The image processing apparatus 100 may further include a profiling data DB 1330 storing profiling data and model parameter memory 1340 storing parameter information of a neural network model. However, not all of the elements shown are essential elements. The image processing apparatus 100 may be implemented by more elements than the shown elements, or may be implemented by fewer elements. In the disclosure, the term “module” may be implemented by executing software, such as program codes, instructions, algorithms, or data structures, stored in memory included in the image processing apparatus 100, by the first processor 110 included in the image processing apparatus 100.

The image processing apparatus 100 shown in FIG. 13 differs from the image processing apparatus 100 in FIG. 4 in that the former does not include a model regeneration module (440 in FIG. 4). In addition, the image processing apparatus 100 shown in FIG. 13 differs from the image processing apparatus 100 in FIG. 4 in that, in the former, the second processor 1320 includes a second parameter identification circuit rather than the first parameter identification circuit.

The first processor 110 may measure through the power consumption measurement module 1310, how much power consumption/heat generation reduction amount must be compared to the current state of the second processor 1320. The power consumption measurement module 1310 may correspond to the power consumption measurement module 410 in FIG. 4.

The second processor 1320 may receive the power consumption reduction request and/or the measured target reduction amount. The second processor 1320 may request data stored in the profiling data DB 1330 through the first processor 110. The second processor 1320 may request access to the model parameter memory 1340 to the first processor 110. In order to transmit parameter information of a neural network model, the first processor 110 may transmit parameter information of a neural network model to be processed by the second processor 1320, or may transmit a location of the memory (e.g., an address of a model parameter memory 1340) to the second processor 1320 so that the second processor 1320 may access the parameter information. Here, the parameter information of the neural network model transmitted by the first processor 110 differs from that of FIG. 4 in that the former includes initial parameter values of the neural network model.

The first processor 110 may load profiling data stored in the profiling data DB 1330. Based on the profiling data, the first processor 110 may identify a threshold value of a parameter for reducing power consumption of a neural network model. The first processor 110 may transmit information about the identified threshold value to the second processor 1320. For example, the first processor 110 may transmit, to the second processor 1320, information indicating a threshold value to the second processor 1320 or a location of a memory in which the information indicating the threshold value is stored. Here, the second processor 1320 is different from that of FIG. 4 in that the former receives information indicating the threshold value.

The first processor 110 may transmit a neural network model execution command to the second processor 1320, and the second processor 1320 may load the input image and the parameter information, and information indicating a threshold value from the memory based on the command so as to perform computation. The second processor 1320 may apply a threshold value to the initial parameters of the neural network model in real time, and perform computation by converting the parameter within the threshold value range to 0 or by considering the parameter to zero. The second processor 1320 may perform control such that an operation of the MAC operator is performed only when the parameter of the neural network model does not fall within the threshold value range.

The second processor 1320 may perform control such that the operation of the MAC operator is not performed, when the parameter of the neural network model falls within the threshold value range through the second parameter identification circuit. The second processor 1320 may perform control such that the operation of the MAC operator is performed only when the parameter of the neural network model does not fall within the threshold value range through the second parameter identification circuit.

FIG. 14 is a block diagram for describing an operator and a second parameter identification circuit of the second processor according to an embodiment of the disclosure. Some features described with respect to FIG. 14 overlap with the descriptions of FIG. 11 are omitted.

FIG. 14 shows a first MAC operator (“M1” in FIG. 14) and a second MAC operator (“M2” in FIG. 14) included in an operator 1400 of the second processor according to an embodiment of the disclosure. Here, the second processor may correspond to the second processor 1320 in FIG. 13.

The first MAC operator may include a multiplier 1410, an adder 1420, and an accumulator 1430. However, the disclosure is not limited thereto. The second MAC operator may include a multiplier 1440, an adder 1450, and an accumulator 1460. However, the disclosure is not limited thereto. For example, in the first MAC operator, the multiplier 1410 may multiply an input weight parameter and feature data, and the adder 1450 and the accumulator 1460 may accumulate the computation values input from the multiplier 1410.

Each MAC operator included in the operator 1400 may include a second parameter identification circuit. The second parameter identification circuit may determine whether a parameter input to each MAC operator falls within a threshold value range. Based on the determination result, the second parameter identification circuit may control the MAC operator that has received the parameter to perform computation only when the parameter does not fall within the threshold value range. When the parameter falls within the threshold value range, the second parameter identification circuit may perform control such that an operation of the MAC operator that has received the parameter is not performed. For example, the second parameter identification circuit may include clock gating circuitry configured to block clock signals for a MAC operator that has received a parameter that falls within the threshold value range.

For example, when the input weight value is greater than the absolute value of the threshold value, the first MAC operator may perform computation on the neural network model based on the input weight value and feature data. For example, when the input weight value is less than the absolute value of the threshold value, the second MAC operator may not perform computation on the neural network mode. That is, the second processor may consider the weight value input to the multiplier as zero and control the MAC operator to not perform a computation operation. Accordingly, the power consumption of the second processor may be reduced and the increase in heat generation may be prevented.

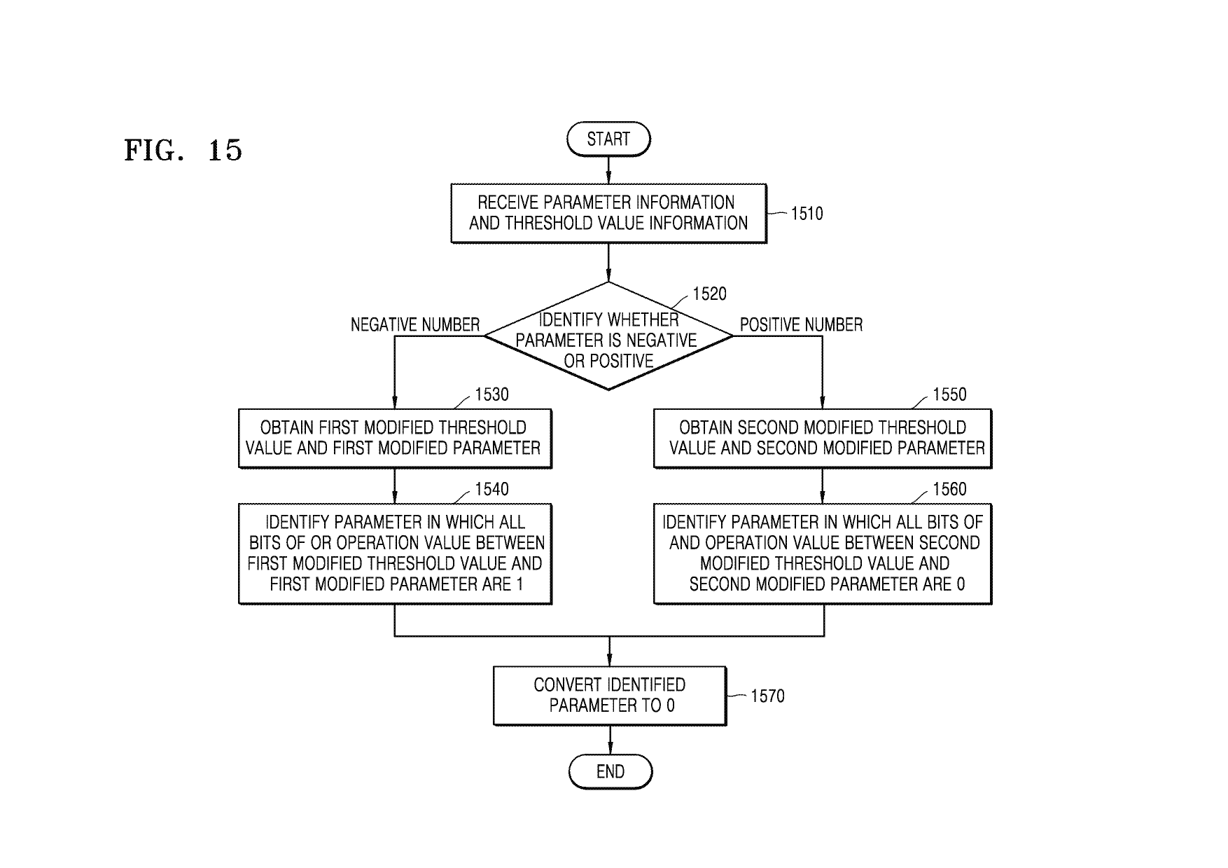

Below, a method by which the second processor 1320 determines whether a parameter of a neural network model falls within a threshold value range by using the second parameter identification circuit is described in more detail with reference to FIGS. 15 to 18.

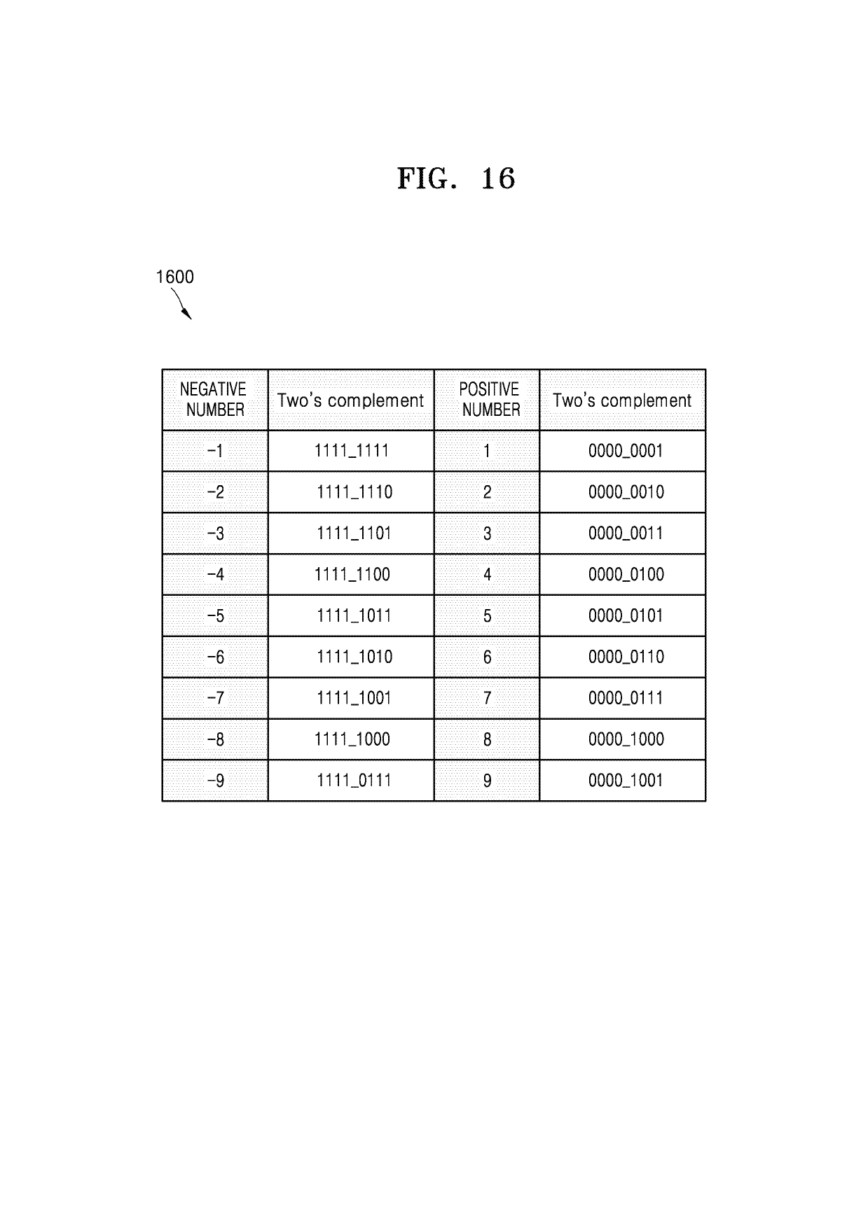

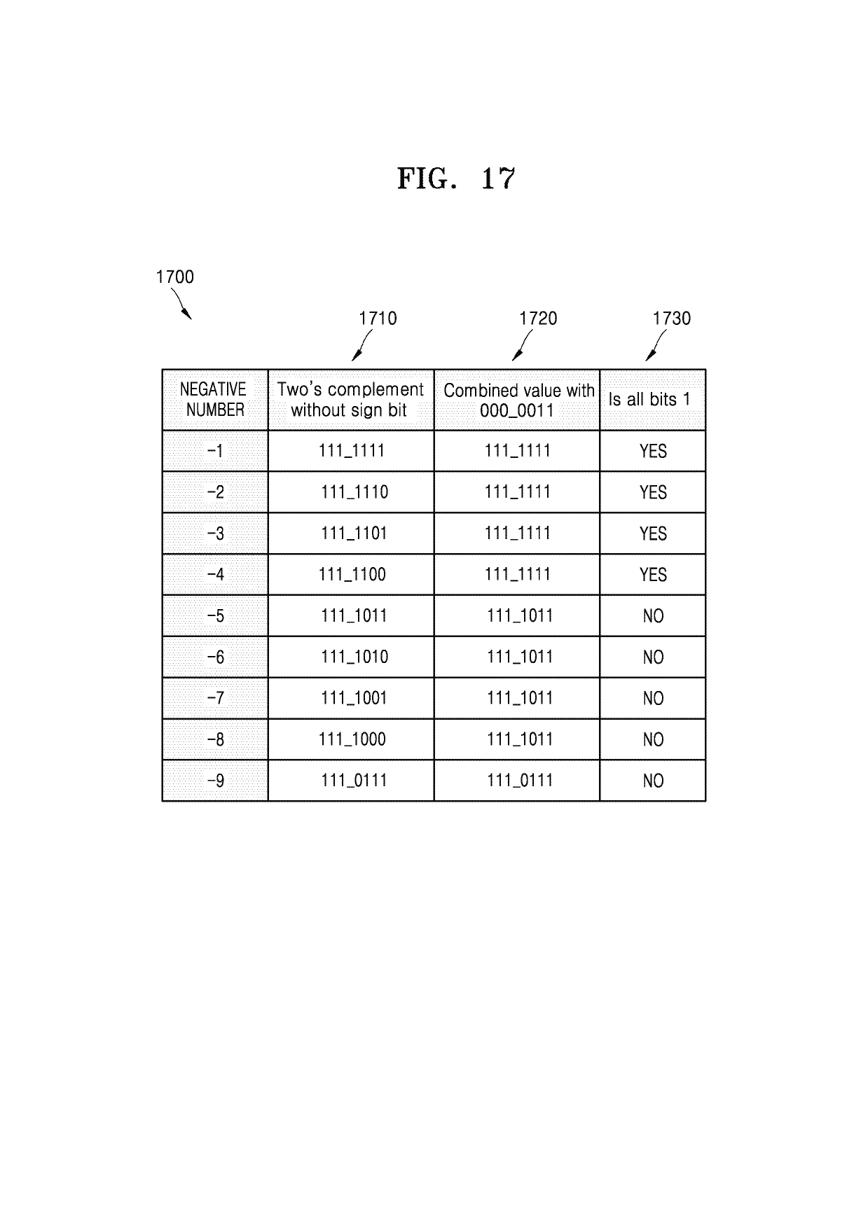

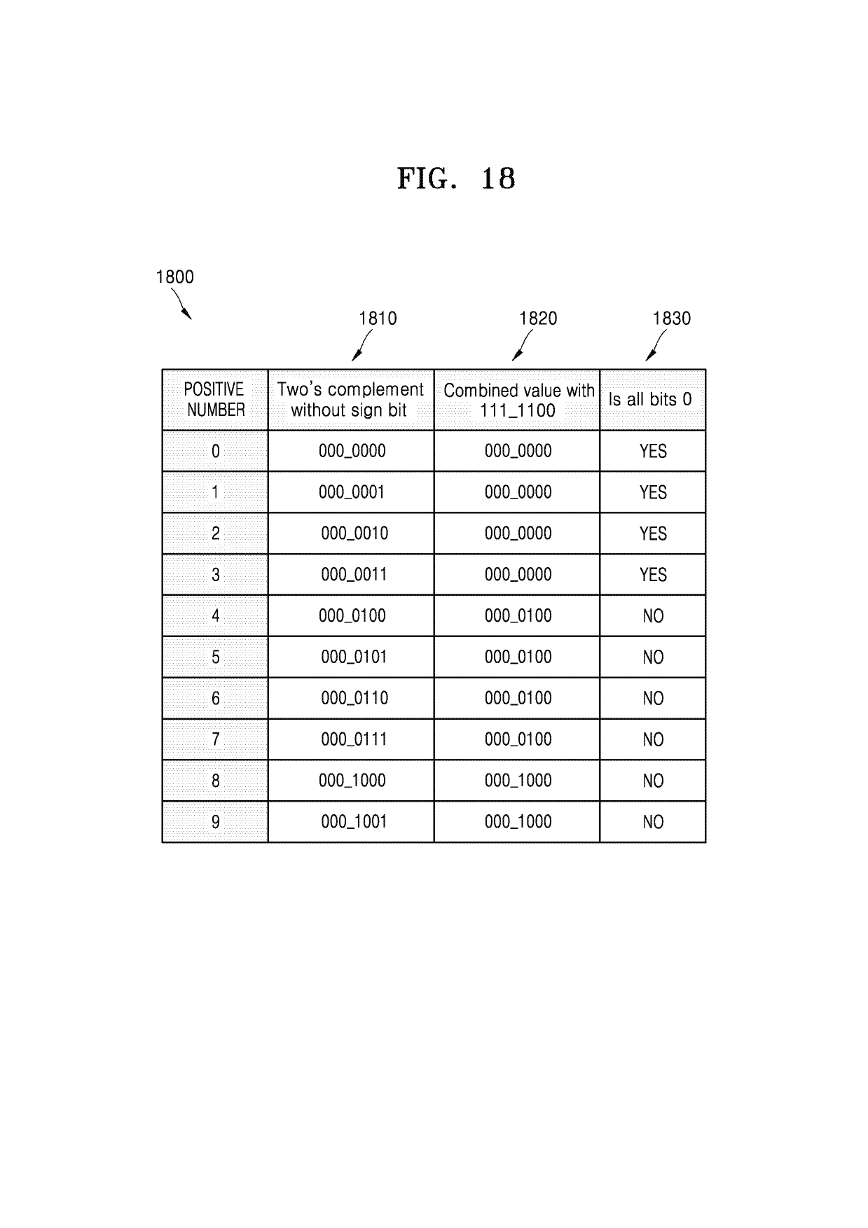

FIG. 15 is a flowchart of a method by which an image processing apparatus according to an embodiment of the disclosure determines whether a parameter of a neural network model is within a threshold value range. FIG. 16 shows a table showing a relationship between decimal and binary numbers in a two’s complement system, which includes sign bits. FIG. 17 is a table for determining whether a parameter input to the second processor is within a threshold value range when the parameter is a negative number, according to an embodiment of the disclosure. FIG. 18 is a table for determining whether a parameter input to the second processor is within a threshold value range when the parameter is a positive number, according to an embodiment of the disclosure.

A table 1600 in FIG. 16 shows a two’s complement representation for negative decimal numbers -1 to -9, and a two’s complement representation for positive binary numbers 1 to 9.

A table 1700 in FIG. 17 shows values related to negative numbers -1 to -9. In a second column 1710, values with a sign bit, which is the first bit, removed from the two’s complement of negative numbers -1 to -9 (hereinafter referred to as “first modified parameter’) are shown. A third column 1720 shows an OR operation value between the first modified parameter and a first modified threshold value is shown, where the first modified threshold value is 000_0011. A fourth column 1730 shows a result of determination as to whether bits of the OR operation value are all 1 or not.

A table 1800 in FIG. 18 shows values related to positive numbers 1 to 9. In a second column 1810, values with a sign bit, which is the first bit, removed from the two’s complement of positive numbers 1 to 9 (hereinafter referred to as “second modified parameter’) are shown. A third column 1820 shows an AND operation value between the second modified parameter and a second modified threshold value is shown, where the second modified threshold value is 111_1100. A fourth column 1830 shows a result of determination as to whether bits of the AND operation value are all 0 or not.

Referring to FIG. 15, in operation 1510, the second processor 120 of the image processing apparatus 100 may receive parameter information and information indicating a threshold value. The second processor 120 may operate according to the following operations, 1520 to 1570, when the received threshold value (e.g., |n| is 2^{p} (where p is an integer). When he received threshold value (e.g., |n|) is not2^{p}, the second processor 120 may operate according to operations 1520 to 1570 by using closest 2^{p}, which is less than the threshold value (e.g., |n|).

For example, it is assumed that the size of the parameter is 8 bits and the threshold value is 4or -4 (where p is 2). The second processor 120 may determine whether the parameter is less than the threshold value by using a threshold value having the same size (bit) as the parameter. For example, the second processor 120 may use 0000_0011, which corresponds to the 8-bit threshold values of 4 or -4. For example, referring to the table 1600, when the threshold value is four, the numbers 0, 1, 2, 3 that are within the threshold value range have all bits set to 0 except for the two least significant bits in their binary representation. Therefore, by using 1111_1100 as the second modified threshold value, the numbers 0, 1, 2, 3 within the positive threshold value may be removed. In addition, for example, when the threshold value is -4, the numbers -1, -2, -3, and -4 that are within the threshold value have all bits set to 1 except for the two least significant bits in their binary representation. Therefore, by using 0000_0011 as the first modified threshold value, the numbers -1, -2, -3, and -4 within the negative threshold value may be removed. Below, a method of calculating a binary threshold value based on the sign of a parameter is described. The parameters and the threshold values may be expressed by using two’s complement.

In operation 1520, the second processor 120 may identify whether the received parameter is negative or positive by using the sign bit of the parameter. For example, the parameter may be negative when the first bit corresponding to the sign bit is 1, and the parameter may be positive when the first bit is 0. For example, in the table 1600 in FIG. 16, when the parameter is 4, the parameter may be expressed as the positive number 0000_0100. For example, when the parameter is -4, the parameter may be expressed as the negative number 1111_1100.

In operation 1530, when the parameter is negative, the first modified threshold value and the first modified parameter may be obtained.

When the first bit (i.e., the most significant bit) of the parameter is 1, indicating a negative number, the second processor 120 may obtain the first modified threshold value by modifying the threshold value received in operation 1510. The first modified threshold value may be a value obtained by removing the first bit of the threshold value. For example, referring to the third column 1720 of the table 1700 in FIG. 17, when the threshold value is 8-bit 0000_0011, the first modified threshold value may be 7-bit 000_0011.

The second processor 120 may obtain the first modified parameter. The first modified parameter may be a value obtained by removing the first bit, which corresponds to the sign bit of the parameter received in operation 1510. For example, referring to the second column 1710 in FIG. 17, when the parameter corresponding to -4 is 8-bit 1111_1100, the first modified parameter may be 7-bit 111_1100.

In operation 540, the second processor 120 may perform an OR operation between the first modified threshold value and the first modified parameter, and identify a parameter in which all bits of the OR operation value are 1.

For example, in the fourth column 1730 of the table 1700 in FIG. 17, the OR operation value between the first modified threshold value and the first modified parameter is represented as “YES” when all bits are 1, and as “NO” when not all bits are 1.

For example, when the received parameter is -4, the first modified threshold value is 000_0011 and the first modified parameter is 111_1100. Therefore, the OR operation value may be 111_1111 (see the third column 1720). In this case, because all bits of the OR operation value are 1, the fourth column 1730 is represented as “YES”. The second processor 120 may identify parameter values corresponding to “YES” (e.g., -1, -2, -3, and -4). The second processor 120 may identify parameter values where -4 ≤ D < 0 for a threshold value D.

In operation 1550, the second processor 120 may obtain a second modified threshold value and a second modified parameter when the parameter is positive.

When the parameter is positive, where the first bit of the parameter is 0, the second processor 120 may modify the threshold value received in operation 1510 and obtain the second modified threshold value. The second modified threshold value may be a value obtained by removing the first bit from the threshold value and switching 0 and 1 to each other. For example, referring to the third column 1820 of the table 1800 in FIG. 18, when the threshold value is 8-bit 0000_0011, the second modified threshold value may be 7-bit 111_1100.

The second processor 120 may obtain the second modified parameter. The second modified parameter may be a value obtained by removing the first bit, which corresponds to the sign bit of the parameter received in operation 1510. For example, referring to the second column 1810 in FIG. 18, when a parameter corresponding to 4 is 8-bit 0000_0100, the second modified parameter may be 7-bit 000_0100. In addition, when a parameter corresponding to 3 is 8-bit 0000_0011, the second modified parameter may be 7-bit 000_0011.

In operation 1560, the second processor 120 may perform an AND operation between the second modified threshold value and the second modified parameter and identify a parameter in which all bits of the AND operation value are 0.

For example, in the fourth column 1830 of the table 1800 in FIG. 18, the AND operation value between the second modified threshold value and the second modified parameter may be represented as “YES” when all bits are 0, and as “NO” when not all bits are 0.

For example, when the received parameter is 4, the second modified threshold value is 111_1100 and the second modified parameter is 000_0100. Therefore, the AND operation value may be 000_0100 (see the third column 1820). In this case, because not all bits of the AND operation value are 0, the AND operation value is represented as “NO” in the fourth column 1830.

For example, when the received parameter is 3, the second modified threshold value is 111_1100 and the second modified parameter is 000_0011. Therefore, the AND operation value may be 000_0000 (see the third column 1820). In this case, because all bits of the AND operation value are 0, the AND operation value is represented as “YES” in the fourth column 1830.

The second processor 120 may identify parameter values corresponding to “YES” (e.g., 0, 1, 2, and 3). The second processor 120 may identify parameter values where 0 ≤ D <4 for the threshold value D. The second processor 120 may identify parameter values where 0 ≤ D < 4, according to operations 1510 to 1560.

In operation 1570, the second processor 120 may convert the identified parameter to 0. For example, as shown in FIG. 13, when the parameter is identified to fall within a threshold value range, the second processor 120 may perform control such that an operation of the MAC operator is not performed. When it is identified that the parameter does not fall within the threshold value range, the second processor 120 may perform control such that the operation of the MAC operator is performed.

The method described above is only an example of a result of a case where p is 2 in the threshold value 2^{p}, and may also be used to identify a parameter value that is less than the threshold value, similar to when the p is an integer other than 2. In addition, the method may be used to identify a value where the parameter is 0, even when the threshold value is set to 0.

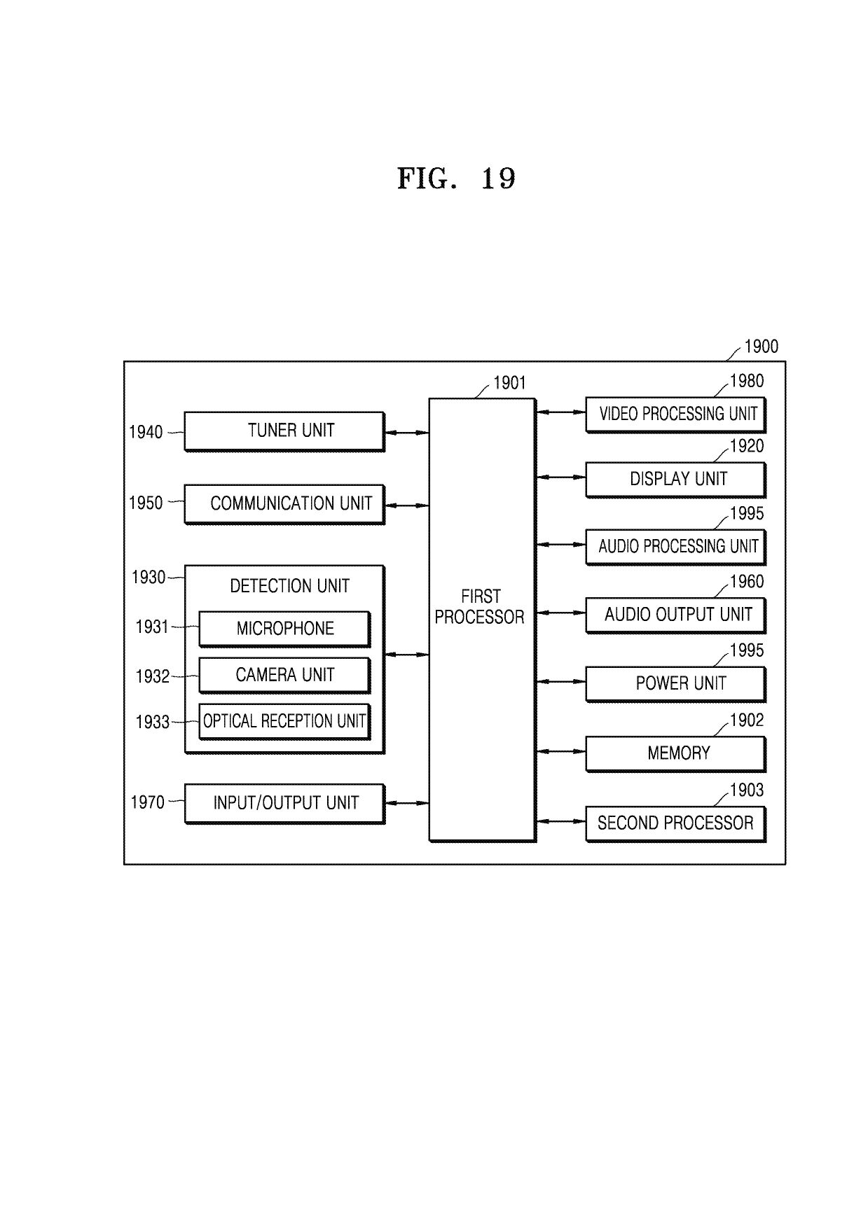

FIG. 19 is a detailed block diagram of an image processing apparatus according to an embodiment of the disclosure.

Referring to FIG. 19, an image processing apparatus 1900 may include a tuner unit 1940, a first processor 1901, memory 1902, a second processor 1903, a display 1920, a communication unit 1950, a detection unit 1930, an input/output unit 1970, a video processing unit 1980, an audio processing unit 1985, an audio output unit 1960, and a power unit 1995. The image processing apparatus 1900 may correspond to the image processing apparatus 100 in FIG. 2. The first processor 1901, the memory 1902, and the second processor 1903 may correspond to the first processor 110, the memory 130, and the second processor 120 in FIG. 2, respectively.

The tuner unit 1940 may tune and select only frequencies of a channel to be received from the image processing apparatus 1900 from among various radio wave components by amplifying, mixing, or resonating a broadcast signal received wirelessly or via a cable. A broadcast signal may include audio, video, and additional information (e.g., an electronic program guide (EPG)).

The tuner unit 1940 may receive broadcast signals from various sources, such as terrestrial broadcasting, cable broadcasting, satellite broadcasting, or Internet broadcasting. The tuner unit 1940 may even receive broadcast signals from a source such as analog broadcasting or digital broadcasting.

The communication unit 1950 may transmit and receive data or signals to and from an external device or server. For example, the communication unit 1950 may include Wireless Fidelity (Wi-Fi) module, Bluetooth module, an infrared communication module and a wireless communication module, a local area network (LAN) module, an Ethernet module, a wired communication module, and the like. In this case, each of the communication modules may be implemented in the form of at least one hardware chip.

The Wi-Fi module and the Bluetooth module may perform communication by using the Wi-Fi scheme and the Bluetooth scheme, respectively. When the Wi-Fi module or the Bluetooth module is used, first, various connection information, such as service set identifier (SSID) and session key, may be transmitted and received, communicative connection is performed by using the same, and then various information may be transmitted and received. The wireless communication module may include at least one communication chip configured to communicate according to various wireless communication specifications, such as ZigBee, 3rd Generation (3G), 3rd Generation Partnership Project (3GPP), Long Term Evolution (LTE), LTE Advanced (LTE-A), 4th Generation (4G), or 5th Generation (5G).

The detection unit 1930 according to an embodiment of the disclosure may detect a user’s voice, a user’s image, or user’s interaction, and may include a microphone 1931, a camera unit 1932, and an optical reception unit 1933.

The microphone 1931 may receive a speech uttered by a user. The microphone 1931 may convert the received speech into an electrical signal and output the electrical signal to the first processor 1901.

The optical reception unit 1933 may receive an optical signal (including a control signal) received from an external control device through a light-transmitting window (not shown) of the bezel of the display 1920, or the like. The optical reception unit 1933 may even receive an optical signal that corresponds to a user input (e.g., touch, press, touch gesture, speech, or motion). A control signal may be extracted from the received optical signal under the control by the first processor 1901.

The input/output unit 1970 may receive video (e.g., moving image, etc.), audio (e.g., speech, music, etc.), and additional information (e.g., an EPG, etc.) from the outside of the image processing apparatus 1900. The input/output unit 1970 may include any one of High-Definition Multimedia Interface (HDMI), Mobile High-Definition Link (MHL), Universal Serial Bus (USB), Display Port (DP), Thunderbolt, Video Graphics Array (VGA) port, RGB port, D-subminiature (D-SUB), Digital Visual Interface (DVI), component jack, and PC port.

The video processing unit 1980 may process video data received by the image processing apparatus 1900. The video processing unit 1980 may perform various image processing, such as decoding, scaling, noise removal, FRC, or resolution conversion, for the video data. For example, the video processing unit 1980 may decode the input video data and scale the decoded video data to be resized to frames for output on a display. The video processing unit 1980 may generate an image-processed output image by applying various image processing algorithm to an input image.

The first processor 1901 may include at least one of a Central Processing Unit (CPU), a Graphics Processing Unit (GPU), or a Video Processing Unit (VPU). The first processor 1901 may be implemented in the form of a System on Chip (SoC), where at least one of the CPU, the GPU, or the VPU is integrated. The first processor 1901 may include a Neural Processing Unit (NPU). The first processor 1901 may be specialized for image processing and may include hard configurations, circuitry, logic, or the like that are required for image processing. For example, the first processor 1901 may include at least one of an Application Specific Integrated Circuit (ASIC) or a Field Programmable Gate Array (FPGA), but is not limited thereto.

In an embodiment of the disclosure, the first processor 110 and the second processor 120 may even be implemented as one integrated chip.

The memory 1902 according to an embodiment of the disclosure may store various data, programs, or applications for driving and controlling the image processing apparatus 1900.

In addition, the program stored in the memory 1902 may include one or more instructions. The program (one or more instructions) or application stored in the memory 1902 may be executed by the first processor 1901.

The first processor 1901 according to an embodiment of the disclosure may execute the one or more instructions stored in the memory 1902 to obtain an input image. The input image may be an image that is pre-stored in the memory 1902, or may even be an image received from an external device through the tuner unit 1940 or the communication unit 1950. In addition, the input image may be an image that is obtained by performing various image processing, such as decoding, scaling, noise removal, FRC, or resolution conversion, in the video processing unit 1980.

The display 1920 may convert image signals, data signals, On-Screen Display (OSD) signals, control signals, etc. processed by the first processor 1901 to generate a driving signal. The display 1920 may be implemented as a Plasma Display Panel (PDP), a Liquid Crystal Display (LCD), an Organic Light-Emitting Display (OLED), a flexible display, etc., and as a three-dimensional (3D) display. In addition, the display 1920 may even be configured as a touch screen and used as an input device in addition to an output device.

The audio processing unit 1985 may process audio data. The audio processing unit 1985 may perform various processing, such as decoding, amplifying, or noise removal, on the audio data. The audio processing unit 1985 may have a plurality of audio processing modules to process audio corresponding to a plurality of items of content.

The audio output unit 1960 may output audio included in a broadcast signal received through the tuner unit 1940, under the control by the first processor 1901. The audio output unit 1960 may output audio (e.g., speech or sound) input through the communication unit 1950 or the input/output unit 1970. In addition, the audio output unit 1960 may output audio stored in the memory 1902, under the control by the first processor 1901. The audio output unit 1960 may include at least one of a speaker, a headphone output terminal, or a Sony/Philips Digital Interface (S/PDIF) output terminal.

The power unit 1995 may supply power that is input from an external power source to elements inside the image processing apparatus 1900, under the control by the first processor 1901. In addition, the power unit 1995 may supply, to the internal elements, power output from one or more batteries (not shown) located inside the image processing apparatus 1900, under the control by the first processor 1901.

The memory 1902 may store various data, programs, or applications for driving and controlling the image processing apparatus 1900, under the control by the first processor 1901.

An image processing apparatus according to an embodiment of the disclosure includes memory storing one or more instructions, the memory including one or more storage media, and at least one processor including processing circuitry. The at least one processor may individually or collectively execute the one or more instructions to cause the image processing apparatus to obtain a power consumption reduction request. The image processing apparatus, in response to obtaining the request, may obtain, based on pre-stored profiling data of a first neural network model, a threshold value of a parameter for converting one or more of parameters of the first neural network model to 0, wherein the profiling data of the first neural network model includes information indicating a threshold value for converting one or more of the parameters of the first neural network model to 0, performance information for a second neural network model in which one or more of the parameters are converted to 0 based on the threshold value, and power consumption reduction estimation information for the second neural network model. The image processing apparatus may obtain, based on the threshold value of the parameter, an image-processed output image from an input image through a second neural network model, where one or more of the parameters of the first neural network model are converted to 0.

The profiling data of the first neural network model according to an embodiment of the disclosure may include at least one of information indicating a threshold value for converting one or more of weights of the first neural network model to 0, quantitative evaluation information for performance of a plurality of second neural network models, where one or more of the weights are converted to 0 based on different threshold values, qualitative evaluation information for the performance of the plurality of second neural network models, or power consumption reduction estimation information for the plurality of second neural network models.

According to an embodiment of the disclosure, when the threshold value increases, the performance of the plurality of second neural network models stored in the profiling data of the first neural network model may decrease, and a power consumption reduction estimation amount may increase.

The at least one first processor according to an embodiment of the disclosure may individually or collectively execute the one or more instructions to cause the image processing apparatus to obtain a power consumption reduction request and a target reduction amount for a second processor, which is configured to perform computation on a neural network model. According to an embodiment of the disclosure, it may be identified a threshold value of at least one second neural network model that has a power consumption reduction estimation amount corresponding to the target reduction amount from among a plurality of second neural network models in which the power consumption reduction estimation amount varies depending on a threshold value within the profiling data.

The at least one first processor according to an embodiment of the disclosure may individually or collectively execute the one or more instructions to cause the image processing apparatus to deactivate the first neural network model when the second neural network from among the plurality of second neural network models does not satisfy minimum performance based on performance of the first neural network model.

The at least one first processor according to an embodiment of the disclosure may individually or collectively execute the one or more instructions to cause the image processing apparatus to, based on power consumption reduction estimation information of each of a plurality of first neural network models of different types included in profiling data of each of the plurality of first neural network models, obtain a threshold value of a parameter corresponding to each of the plurality of first neural network models. The image processing apparatus, based on the threshold value of the parameter corresponding to each of the plurality of first neural network models, may obtain the image-processed output image from the input image through a plurality of second neural network models respectively corresponding to the plurality of first neural network models.

The at least one first processor according to an embodiment of the disclosure may individually or collectively execute the one or more instructions to cause the image processing apparatus to determine whether to deactivate at least one first neural network model from among the plurality of first neural network models, based on a deactivation priority included in the profiling data of each of the plurality of first neural network models.

The image processing apparatus according to an embodiment of the disclosure may further include a second processor including a multiple operators.

The at least one first processor according to an embodiment of the disclosure may individually or collectively execute the one or more instructions to cause the image processing apparatus to obtain the image processed output image from the input image by performing, through the second processor, an operation on an first operator when a parameter input to the operator is not within a threshold value range, and by not performing an operation on the operator when a parameter input to the operator is within a threshold value range.

The at least one first processor according to an embodiment of the disclosure may individually or collectively execute the one or more instructions to cause the image processing apparatus to generate the second neural network model by converting a parameter of the first neural network model within a parameter within a range of the threshold value of the parameter to 0. The image processing apparatus may transmit parameter information of the second neural network model and the input image to the second processor. The image processing apparatus may obtain the image processed output image from the input image by performing, through the second processor, an operation on the operator when a parameter input to the operator is non-zero, and by not performing an operation on the operator when a parameter input to the operator is zero.

The at least one first processor according to an embodiment of the disclosure may individually or collectively execute the one or more instructions to cause the image processing apparatus to transmitting parameter information of the first neural network model, information indicating a threshold value of the parameter, and the input image to the second processor. The image processing apparatus may obtain the image processed output image from the input image by performing, through the second processor, an operation on the operator when a parameter input to the operator is not within a threshold value range, and by not performing an operation on the operator when a parameter input to the operator is within a threshold value range.

The at least one first processor according to an embodiment of the disclosure may individually or collectively execute the one or more instructions to cause the image processing apparatus to, as an operation for identifying whether the parameter is within the threshold value range, when the received parameter is negative and the received threshold value is 2^{p}, perform an OR operation between a first modified threshold value and a first modified parameter, and identify a parameter in which all bits of a value of the OR operation are 1. The image processing apparatus, when the received parameter is positive and the received threshold value is 2^{p}, may perform an AND operation between a second modified threshold value and a second modified parameter, and identify a parameter in which all bits of a value of the AND operation are 0.

According to an embodiment of the disclosure, an operating method of an image processing apparatus includes obtaining a power consumption reduction request, when the request is obtained, obtaining, based on pre-stored profiling data of a first neural network model, a threshold value of a parameter for converting one or more of parameters of the first neural network model to 0, wherein the profiling data of the first neural network model includes information indicating a threshold value for converting one or more of the parameters of the first neural network model to 0, performance information for a second neural network model in which one or more of the parameters are converted to 0 based on the threshold value, and power consumption reduction estimation information for the second neural network model, and obtaining, based on the threshold value of the parameter, an image-processed output image from an input image through the second neural network model, where one or more of the parameters of the first neural network model are converted to 0.

The profiling data of the first neural network model according to an embodiment of the disclosure may include at least one of information indicating a threshold value for converting one or more of weights of the first neural network model to 0, quantitative evaluation information for performance of a plurality of second neural network models, where one or more of the weights are converted to 0 based on different threshold values, qualitative evaluation information for the performance of the plurality of second neural network models, or power consumption reduction estimation information for the plurality of second neural network models.

According to an embodiment of the disclosure, when the threshold value increases, the performance of the plurality of second neural network models stored in the profiling data of the first neural network model may decrease, and a power consumption reduction estimation amount may increase.

The obtaining of the power consumption reduction request, according to an embodiment of the disclosure, may include obtaining a power consumption reduction request and target reduction amount for a second processor, which is configured to perform computation on a neural network model.

The obtaining of the threshold value of the parameter according to an embodiment of the disclosure may include identifying a threshold value of at least one second neural network model that has a power consumption reduction estimation amount corresponding to the target reduction amount from among a plurality of second neural network models in which the power consumption reduction estimation amount varies depending on a threshold value within the profiling data.

The operating method of the image processing apparatus, according to an embodiment of the disclosure, may further include determining to deactivate the first neural network model when the second neural network from among the plurality of second neural network models does not satisfy minimum performance based on performance of the first neural network model.

The operating method of the image processing apparatus, according to an embodiment of the disclosure, may include determining whether to deactivate at least one first neural network model from among the plurality of first neural network models, based on a deactivation priority included in the profiling data of each of the plurality of first neural network models.

The operating method of the image processing apparatus, according to an embodiment of the disclosure, may further include, based on power consumption reduction estimation information of each of a plurality of first neural network models of different types included in profiling data of each of the plurality of first neural network models, obtaining a threshold value of a parameter corresponding to each of the plurality of first neural network models, and based on the threshold value of the parameter corresponding to each of the plurality of first neural network models, obtaining the image-processed output image from the input image through a plurality of second neural network models respectively corresponding to the plurality of first neural network models.

The obtaining of the image-processed output image from the input image through the second neural network model, according to an embodiment of the disclosure, may include obtaining the image processed output image from the input image by performing, via a second processor, an operation on an operator when a parameter input to the operator is not within a threshold value range, and by not performing an operation on an operator when a parameter input to the operator is within a threshold value range.

The obtaining of the image-processed output image from the input image through the second neural network model, according to an embodiment of the disclosure, may include generating the second neural network model by converting a parameter of the first neural network model within a threshold value range of the parameter to 0, transmitting parameter information of the second neural network model and the input image to a second processor, and obtaining the image processed output image from the input image by performing, via a second processor, an operation on an operator when a parameter input to the operator is non-zero, and by not performing an operation on an operator when a parameter input to the operator is zero.

The obtaining of the image processed output image from the input image through the second neural network model, according to an embodiment of the disclosure, may include transmitting parameter information of the first neural network model, information indicating a threshold value of the parameter, and the input image to the second processor, and obtaining the image processed output image from the input image by performing, through the second processor, an operation on an operator when a parameter input to the operator is not within a threshold value range, and by not performing an operation on an operator when a parameter input to the operator is within a threshold value range.

A machine-readable storage medium may be provided in the form of a non-transitory storage medium. Here, the “non-transitory storage medium” only denotes a tangible device and does not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

According to an embodiment of the disclosure, a method according to various embodiments disclosed in the present specification may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

What is claimed is:

1. An image processing apparatus comprising:
memory storing one or more instructions; and
at least one processor,
wherein the one or more instructions, when executed by the at least one processor, individually or collectively, cause the image processing apparatus to:
obtain a power consumption reduction request;
in response to the power consumption reduction request, obtain, from pre-stored profiling data of a first neural network model, a threshold value for converting one or more parameters of the first neural network model to zero, wherein the profiling data comprises (i) information indicating the threshold value, (ii) performance information for a second neural network model that is generated by converting the one or more parameters of the first neural network model to zero based on the threshold value, and (iii) power consumption reduction estimation information for the second neural network model; and
obtain an output image from the second neural network model by processing an input image through the second neural network model.

2. The image processing apparatus of claim 1, wherein the profiling data further comprises at least one of: (i) quantitative evaluation information for performance of a plurality of second neural network models in which one or more weights are converted to zero based on different threshold values, or (ii) qualitative evaluation information for the performance of the plurality of second neural network models.

3. The image processing apparatus of claim 2, wherein, as the threshold value increases, the performance of the plurality of second neural network models decreases and a power consumption reduction estimation amount of the plurality of second neural network models increases.

4. The image processing apparatus of claim 2, wherein the at least one processor comprises at least one first processor and a second processor, wherein the one or more instructions, when executed by the at least one first processor, individually or collectively, cause the image processing apparatus to:
obtain a target reduction amount with the power consumption reduction request for the second processor; and
identify, from the profiling data, a threshold value for at least one second neural network model having a power consumption reduction estimation amount that corresponds to the target reduction amount.

5. The image processing apparatus of claim 4, wherein the one or more instructions, when executed by the at least one processor, individually or collectively, cause the image processing apparatus to deactivate the first neural network model in response to the at least one second neural network model failing to satisfy a minimum performance that is based on the performance of the first neural network model.

6. The image processing apparatus of claim 1, wherein the one or more instructions, when executed by the at least one processor, individually or collectively, cause the image processing apparatus to:
obtain corresponding threshold values for parameters of a plurality of first neural network models of different types, based on power consumption reduction estimation information in the profiling data for the plurality of first neural network models; and
obtain the output image by processing the input image through a plurality of second neural network models corresponding to the plurality of first neural network models.

7. The image processing apparatus of claim 6, wherein the one or more instructions, when executed by the at least one processor, individually or collectively, cause the image processing apparatus to deactivate at least one first neural network model from among the plurality of first neural network models, based on a deactivation priority included in the profiling data.

8. The image processing apparatus of claim 1, wherein the at least one processor comprises at least one first processor and a second processor, the second processor comprising a plurality of operators,
wherein the one or more instructions, when executed by the at least one first processor, individually or collectively, cause the image processing apparatus to use the second processor to obtain the output image by:
performing, via the second processor, an operation using an operator of the plurality of operators based on a parameter input to the operator not being within a threshold value range; and
not performing the operation based on a parameter input to the operator being within the threshold value range.

9. The image processing apparatus of claim 1, wherein the at least one processor comprises at least one first processor and a second processor, the second processor comprising a plurality of operators, and wherein the one or more instructions, when executed by the at least one first processor, individually or collectively, cause the image processing apparatus to:
generate the second neural network model by converting a parameter of the first neural network model to zero based on the parameter having a value within a threshold value range;
transmit, to the second processor, parameter information of the second neural network model and the input image; and
cause the image processing apparatus to use the second processor to obtain the output image by:
performing, via the second processor, an operation using an operator of the plurality of operators based on a parameter input to the operator being non-zero; and
not performing the operation based on the parameter input to the operator being zero.

10. The image processing apparatus of claim 1, wherein the at least one processor comprises at least one first processor and a second processor, the second processor comprising a plurality of operators, and wherein the one or more instructions, when executed by the at least one first processor, cause the image processing apparatus to:
transmit, to the second processor, parameter information of the first neural network model, information indicating the threshold value, and the input image; and
cause the image processing apparatus to use the second processor to obtain the output image by:
performing, via the second processor, an operation using an operator of the plurality of operators based on a parameter input to the operator not being within a threshold value range; and
not performing the operation based on the parameter input to the operator being within the threshold value range.

11. The image processing apparatus of claim 8, wherein the parameter input to the operator is determined to be within the threshold value range by:
based on the parameter being negative and the threshold value being 2^{p}, where p is an integer, performing an OR operation between a first modified threshold value and a first modified parameter, and identifying the parameter as being within the threshold value range when all bits of a result of the OR operation are one; and
based on the parameter being positive and the threshold value being 2^{p}, performing an AND operation between a second modified threshold value and a second modified parameter, and identifying the parameter as being within the threshold value range when all bits of a result of the AND operation are zero.

12. An operating method of an image processing apparatus, the operating method comprising:
obtaining a power consumption reduction request;
in response to the power consumption reduction request, obtaining, from pre-stored profiling data of a first neural network model, a threshold value for converting one or more parameters of the first neural network model to zero, wherein the profiling data comprises (i) information indicating the threshold value, (ii) performance information for a second neural network model that is generated by converting the one or more parameters of the first neural network model to zero based on the threshold value, and (iii) power consumption reduction estimation information for the second neural network model; and
obtaining an output image from the second neural network model by processing an input image through the second neural network model.

13. The operating method of claim 12, wherein the profiling data further comprises at least one of: (i) quantitative evaluation information for performance of a plurality of second neural network models in which one or more weights are converted to zero based on different threshold values, or (ii) qualitative evaluation information for the performance of the plurality of second neural network models.

14. The operating method of claim 13, wherein, as the threshold value increases, the performance of the plurality of second neural network models decreases and a power consumption reduction estimation amount of the plurality of second neural network models increases.

15. The operating method of claim 13, further comprising:
obtaining a target reduction amount with the power consumption reduction request for a second processor; and
identifying, from the profiling data, a threshold value for at least one second neural network model having a power consumption reduction estimation amount that corresponds to the target reduction amount.

16. The operating method of claim 15, further comprising deactivating the first neural network model in response to the at least one second neural network model failing to satisfy a minimum performance that is based on the performance of the first neural network model.

17. The operating method of claim 12, further comprising:
obtaining corresponding threshold values for parameters of a plurality of first neural network models of different types, based on power consumption reduction estimation information in the profiling data for the plurality of first neural network models; and
obtaining the output image by processing the input image through a plurality of second neural network models corresponding to the plurality of first neural network models.

18. The operating method of claim 17, further comprising deactivating at least one first neural network model from among the plurality of first neural network models, based on a deactivation priority included in the profiling data.

19. The operating method of claim 12, wherein the obtaining of the output image comprises:
performing, via a second processor, an operation using an operator of a plurality of operators based on a parameter input to the operator not being within a threshold value range; and
not performing the operation based on a parameter input to the operator being within the threshold value range.

20. A non-transitory computer-readable recording medium having at least one instruction recorded thereon, that, when executed by at least one processor, individually or collectively, causes the at least one processor to:
obtain a power consumption reduction request;
in response to the power consumption reduction request, obtain, from pre-stored profiling data of a first neural network model, a threshold value for converting one or more parameters of the first neural network model to zero, wherein the profiling data comprises (i) information indicating the threshold value, (ii) performance information for a second neural network model that is generated by converting the one or more parameters of the first neural network model to zero based on the threshold value, and (iii) power consumption reduction estimation information for the second neural network model; and
obtain an output image from the second neural network model by processing an input image through the second neural network model.
